(19) United States
(12) Patent Application Publication
(10) Pub. No.: US 2026/0360820 A1
(43) Pub. Date: Nov. 12, 2026

(54) High Purity Electrolyte Compositions and Battery Cells

(71) Applicant: Mana Battery, Inc., Broomfield, CO (US)

(72) Inventors: Nicholas R. Singstock, Longmont, CO (US); Tyler J. Evans, Denver, CO (US); Heather A.S. Platt, Golden, CO (US)

(21) Appl. No.: 19/720,496

(22) Filed: Jun. 25, 2026

Related U.S. Application Data
(63) Continuation of application No. PCT/US2025/050592, filed on Oct. 10, 2025.
(60) Provisional application No. 63/706,529, filed on Oct. 11, 2024.

(51) Int. Cl. H01M 10/0569; B60L 50/64; H01M 10/0525; H01M 10/0567; H01M 10/0568

(52) U.S. Cl. CPC H01M 10/0569; H01M 10/0525; H01M 10/0567; H01M 10/0568; B60L 50/64; H01M 2300/0028

(57) ABSTRACT

The present relates to the field of energy storage devices such as lithium-ion batteries, sodium-ion batteries, and sodium anode-free batteries. More specifically, the disclosure provide room temperature liquid electrolyte compositions separately and in combination as used in lithium and sodium-based batteries.

### FIELD

This disclosure relates to the field of energy storage devices such as lithium-ion batteries, sodium-ion batteries, and sodium anode-free batteries. More specifically, the disclosure relates to the field of room temperature liquid electrolyte compositions separately and in combination as used in lithium and sodium-based batteries.

### BACKGROUND

Electrolytes for secondary batteries based on the reversible shuttling of lithium or sodium ions are generally composed of three primary components: an alkali salt (e.g., LiX, NaX, where X is a monovalent anion), a solvent or mix of solvents, and additives. While a multitude of additive chemistries exist to improve cell performance and a wide range of solvents may often be considered, generally there are few commercially-viable alkali salts. The most prevalent of these salts is based on the hexafluorophosphate (PF₆⁻) anion (e.g., LiPF₆/NaPF₆), that provides a suitably stable interface at many anode materials, achieves high Coulombic efficiency (CE) in many cell designs, and facilitates high ionic conductivity of the electrolyte. However, salts of the PF₆⁻ anion are highly susceptible to decomposition with water, and can generate toxic gaseous byproducts (e.g., HF, PF₃). Moreover, these salts tend to require multiple expensive processing steps to manufacture and often use toxic HF as a major precursor. Other alkali salts also have limitations: perchlorate (ClO₄⁻) salts tend to be explosive and yield lower CE, bis(fluorosulfonyl)imide (i.e., FSI) and bis(trifluoromethylsulfonyl)imide (i.e., TFSI) salts are expensive to manufacture and corrode traditional current collector materials such as aluminum, and tetrafluoroborate (BF₄⁻) salts tend to have poor dissociation and consequently low ionic conductivity. Given the boom in demand for high energy secondary battery chemistries for electric vehicles and grid energy storage, there is a large need and opportunity for alkali salts that provide high CE, stable interphases, and high ionic conductivity, while providing superior stability against water, and leveraging low cost materials and simple manufacturing to reduce costs.

### SUMMARY

The present disclosure provides high purity electrolyte compositions containing borate ester salts, as well as methods for making these electrolyte compositions. One class of alkali salts are tetrahedral borate ester salts, with the anion formula B(OR)₄⁻, which provide promising metrics including high conductivity and reversible shuttling of alkali cations (e.g., Li⁺ and Na⁺). These alkali salts are traditionally produced by the reaction of LiBH₄ or NaBH₄ with an alcohol in 1,2-dimethoxyethane (DME) solvent, followed by vacuum drying to yield the LiB(OR)₄ or NaB(OR)₄ salt. However, some of the DME molecules remain coordinated to the borate ester salt even following vacuum drying at elevated temperatures. Particular dried borate ester salts containing the hexafluoro-2-propanol (hfip) ligand, such as LiB(hfip)₄ and NaB(hfip)₄, have been synthesized with 1 to 3 coordinated DME molecules per molecule of salt. Consequently, approximately 11-28 wt % of the dried mass of salt can be DME, which can cause poor oxidative stability, decreased cycling performance, and increased electrolyte mass. A 1M LiB(hfip)₄ or NaB(hfip)₄ electrolyte would therefore contain 1-3M (molar) DME impurity, resulting in 8-20 wt % of the total solvent being DME. Improving purity by removing coordinated DME from the electrolyte is a major obstacle to the viability of many borate ester salts for applications in secondary batteries. In some embodiments, the present disclosure provides high purity electrolytes containing borate ester salts substantially free of DME contamination, as well as methods for making these electrolytes, and energy storage devices or batteries including such electrolyte compositions. In some embodiments, the electrolyte contains borate ester salt(s) dissolved in a liquid solvent, and is substantially free of DME. In some embodiments, the electrolyte contains borate ester salt(s) dissolved in a liquid solvent with no DME contamination.

In some embodiments, an electrolyte composition for use in sodium-based batteries is described. The electrolyte composition includes at least one sodium borate ester salt having the formula NaB(OR)₄, and at least one solvent wherein the solvent is substantially free of 1,2-dimethoxyethane (DME). As used herein, the term “substantially free” in reference to the presence, or lack thereof, of 1,2-dimethoxyethane (DME) in a composition of this disclosure, refers to an amount of less than 8% by weight. In some embodiments, a composition substantially free of DME has less than 7 wt % of DME, such as less than 6 wt %, less than 5 wt %, less than 4 wt %, less than 3 wt %, less than 2 wt %, or less than 1 wt %, less than 0.5 wt %, less than 0.1 wt % DME, or no DME.

In some embodiments, 1,2-dimethoxyethane (DME) is an optional component that is <8 wt % of the total solvent of the electrolyte, such as <7 wt %, <6 wt %, <5 wt %, <4 wt %, <3 wt %, <2 wt %, or <1 wt % of the total solvent of the electrolyte. In some embodiments of the sodium borate ester salt having the formula NaB(OR)₄, the R group may be an alkyl group, a fluoroalkyl group, a carboxy group, a fluoro-carboxyl group, a phenyl group, a fluoro-phenyl group, or a functionalized phenyl group. The solvent may be a carbonate solvent, cyclic carbonate solvent, ester solvent, cyclic ester solvent, ether solvent, cyclic ether solvent, fluoro-ether solvent, phosphate solvent, phosphite solvent, sulfate solvent, cyclic sulfate solvent, sulfone solvent, sultone solvent, sulfite solvent, triglyceride solvent, anhydride solvent, amide solvent, or combination thereof.

In some embodiments, an electrolyte composition for use in sodium-based batteries is described. The electrolyte composition includes at least one sodium borate ester salt selected from sodium tetra(hexafluoro isopropoxy)borate, sodium tetra(1,1,1-trifluoro isopropoxy)borate, sodium tetra(2-trifluoromethyl isopropoxy)borate, sodium tetra(trifluoro ethoxy)borate, sodium tetra(difluoro ethoxy)borate, sodium bis(perfluoro pinacolato)borate, sodium tetra(pentafluoro phenoxy)borate, sodium tetra(perfluoro tertbutoxy)borate, sodium tetra(trifluoro acetoxy)borate, sodium tetra(3-methylphenoxy)borate, sodium tetra(4-methylphenoxy)borate, sodium tetra(2-fluoro-3-methylphenoxy)borate, sodium tetra(4-fluoro-3-methylphenoxy)borate, sodium tetra(2-fluoro-5-methylphenoxy)borate, sodium tetra(4-cyano phenoxy)borate, sodium tetra(3-cyano phenoxy)borate, sodium tetra(3,4-dicyano phenoxy)borate, sodium tetra(3,5-dicyano phenoxy)borate, sodium tetra(3-cyano-5-fluoro phenoxy)borate, sodium tetra(1-phenyl-2,2,2-trifluoro ethoxy)borate, sodium tetra(1-cyano-2,2,2-trifluoro ethoxy)borate, sodium tetra(1,1,1-trifluoro-2-cyano isopropoxy)borate, sodium tetra(2-cyano isopropoxy)borate, sodium tetra(1-cyano isopropoxy)borate, sodium tetra(2-cyano ethoxy)borate, sodium tetra(1-cyano-1-methoxy methoxy)borate, sodium tetra(1-cyano-1-ethoxy methoxy)borate, sodium tetra(1-cyano-1-phenyl methoxy)borate, sodium tetra(2-cyano-1-methoxy ethoxy)borate, and sodium tetra(2-cyano-1-ethoxy ethoxy)borate, sodium tetra(methysulfonyl)borate, sodium tetra(trifluoromethysulfonyl)borate, and sodium tetra(trimethylsiloxy)borate.

In some embodiments, an electrolyte composition for use in lithium-based batteries is described. The electrolyte composition includes at least one lithium borate ester salt having the formula LiB(OR)₄, and at least one solvent substantially free of 1,2-dimethoxyethane (DME). The R group may be an alkyl group, a fluoroalkyl group, a carboxy group, a fluoro-carboxyl group, a phenyl group, a fluoro-phenyl group, or a functionalized phenyl group. The solvent may be a carbonate solvent, cyclic carbonate solvent, ester solvent, cyclic ester solvent, ether solvent, cyclic ether solvent, fluoro-ether solvent, phosphate solvent, phosphite solvent, sulfate solvent, cyclic sulfate solvent, sulfone solvent, sultone solvent, sulfite solvent, triglyceride solvent, anhydride solvent, amide solvent, or combination thereof, where the total solvent is comprised of solvents that are substantially free of DME.

In some embodiments, an electrolyte composition for use in lithium-based batteries is described. The electrolyte composition includes at least one lithium borate ester salt selected from lithium tetra(hexafluoro isopropoxy)borate, lithium tetra(1,1,1-trifluoro isopropoxy)borate, lithium tetra(2-trifluoromethyl isopropoxy)borate, lithium tetra(trifluoro ethoxy)borate, lithium tetra(difluoro ethoxy)borate, lithium bis(perfluoro pinacolato)borate, lithium tetra(pentafluoro phenoxy)borate, lithium tetra(perfluoro tertbutoxy)borate, lithium tetra(trifluoro acetoxy)borate, lithium tetra(3-methylphenoxy)borate, lithium tetra(4-methylphenoxy)borate, lithium tetra(2-fluoro-3-methylphenoxy)borate, lithium tetra(4-fluoro-3-methylphenoxy)borate, lithium tetra(2-fluoro-5-methylphenoxy)borate, lithium tetra(4-cyano phenoxy)borate, lithium tetra(3-cyano phenoxy)borate, lithium tetra(3,4-dicyano phenoxy)borate, lithium tetra(3,5-dicyano phenoxy)borate, lithium tetra(3-cyano-5-fluoro phenoxy)borate, lithium tetra(1-phenyl-2,2,2-trifluoro ethoxy)borate, lithium tetra(1-cyano-2,2,2-trifluoro ethoxy)borate, lithium tetra(1,1,1-trifluoro-2-cyano isopropoxy)borate, lithium tetra(2-cyano isopropoxy)borate, lithium tetra(1-cyano isopropoxy)borate, lithium tetra(2-cyano ethoxy)borate, lithium tetra(1-cyano-1-methoxy methoxy)borate, lithium tetra(1-cyano-1-ethoxy methoxy)borate, lithium tetra(1-cyano-1-phenyl methoxy)borate, lithium tetra(2-cyano-1-methoxy ethoxy)borate, lithium tetra(2-cyano-1-ethoxy ethoxy)borate, lithium tetra(methysulfonyl)borate, lithium tetra(trifluoromethysulfonyl)borate, and lithium tetra(trimethylsiloxy)borate.

In some embodiments, a method of forming an electrolyte composition for use in a sodium-based battery is described. The method includes a step of combining or adding sodium borohydride, a solvent or blend of multiple solvents that is not DME, and an acidic precursor. In some embodiments, the acidic precursor may be an alcohol, a fluorinated alcohol, a phenol, a fluorinated phenol, a ketone, a fluorinated ketone, a carboxylic acid, a fluorinated carboxylic acid, a diol, or a fluorinated diol. Combining the sodium borohydride, solvent, and acidic precursor forms a solution comprising the solvent and a sodium borate ester salt having the formula NaB(OR)₄. The solution containing the sodium borate ester and solvent may be used as an electrolyte for sodium-based batteries without further drying to remove solvent.

It is understood that the acidic precursor is capable of reacting with the sodium borohydride to produce a sodium borate ester salt.

In some embodiments, the method described herein may be performed in a single batch reactor. The batch reactor may operate in the range of −20 °C to 150 °C. The reactor may include stirring, mixing, agitating, refluxing, or a combination thereof. The reactor may be fitted to safely vent hydrogen gas formed during reaction. The reactor may be operated in a pressure range of 0.1 to 100 atm. The reaction time can be between 0 and 72 hours. The reactor can be operated to a conversion of sodium borohydride ranging from 50% to 100%; and ideally to >99%. The reactor may include a catalyst to increase reaction conversion or decrease reaction time. The reactor may include in-situ monitoring of key properties including temperature, conductivity, time, pressure, pH, humidity, color, transmission, spectroscopic properties, density, water content, and others. Reaction conversion and purity may be determined via several methods, either in-situ or ex-situ, including Karl Fischer titration, conductivity measurement, Fourier-transform infrared spectroscopy, Raman spectroscopy, nuclear magnetic resonance, gas chromatography, liquid chromatography, spectroscopy, thermogravimetric analysis, calorimetry, inductively coupled plasma mass spectrometry, and others.

In some embodiments, the method described herein may be performed in a continuous stirred tank reactor. The continuous reactor may operate in the range of −20 °C to 150 °C. The reactor may include stirring, mixing, agitating, refluxing, or a combination thereof. The reactor may be fitted to safely vent hydrogen gas formed during reaction. The reactor may be operated in a pressure range of 0.1 to 100 atm. The reaction time can be between 0 and 72 hours. The reactor can be operated to a conversion of sodium borohydride ranging from 50% to 100%; and ideally to >99%. The reactor may include a recycle stream. The reactor may include a catalyst to increase reaction conversion or decrease reaction time. The reactor may include in-situ monitoring of key properties including temperature, conductivity, time, pressure, pH, humidity, color, transmission, spectroscopic properties, density, water content, gas flow, and others. Reaction conversion and purity may be determined via several methods, either in-situ or ex-situ, including Karl Fischer titration, conductivity measurement, Fourier-transform infrared spectroscopy, Raman spectroscopy, nuclear magnetic resonance, gas chromatography, liquid chromatography, spectroscopy, thermogravimetric analysis, calorimetry, inductively coupled plasma mass spectrometry, and others.

In some embodiments, a method of forming an electrolyte composition for use in a lithium-based battery is described. The method includes a step of adding lithium borohydride, a solvent or blend of multiple solvents that is not DME, and an acidic precursor. The acidic precursor may be an alcohol, a fluorinated alcohol, a ketone, a fluorinated ketone, a carboxylic acid, a fluorinated carboxylic acid, a diol, or a fluorinated diol. Combining the lithium borohydride, solvent, and acidic precursor forms a solution comprising the solvent and a lithium borate ester salt having the formula LiB(OR)₄. The solution containing the lithium borate ester and solvent may be used as an electrolyte for lithium-based batteries without further drying to remove solvent.

In some embodiments, the method described herein may be performed in a single batch reactor. The batch reactor may operate in the range of −20 °C to 150 °C. The reactor may include stirring, mixing, agitating, refluxing, or a combination thereof. The reactor may be fitted to safely vent hydrogen gas formed during reaction. The reactor may be operated in a pressure range of 0.1 to 100 atm. The reaction time can be between 0 and 72 hours. The reactor can be operated to a conversion of lithium borohydride ranging from 50% to 100%; and ideally to >99%. The reactor may include a catalyst to increase reaction conversion or decrease reaction time. The reactor may include in-situ monitoring of key properties including temperature, conductivity, time, pressure, pH, humidity, color, transmission, spectroscopic properties, density, water content, and others. Reaction conversion and purity may be determined via several methods, either in-situ or ex-situ, including Karl Fischer titration, conductivity measurement, Fourier-transform infrared spectroscopy, Raman spectroscopy, nuclear magnetic resonance, gas chromatography, liquid chromatography, spectroscopy, thermogravimetric analysis, calorimetry, inductively coupled plasma mass spectrometry, and others.

In some embodiments, the method described herein may be performed in a continuous stirred tank reactor. The continuous reactor may operate in the range of −20 °C to 150 °C. The reactor may include stirring, mixing, agitating, refluxing, or a combination thereof. The reactor may be fitted to safely vent hydrogen gas formed during reaction. The reactor may be operated in a pressure range of 0.1 to 100 atm. The reaction time can be between 0 and 72 hours. The reactor can be operated to a conversion of lithium borohydride ranging from 50% to 100%; and ideally to >99%. The reactor may include a recycle stream. The reactor may include a catalyst to increase reaction conversion or decrease reaction time. The reactor may include in-situ monitoring of key properties including temperature, conductivity, time, pressure, pH, humidity, color, transmission, spectroscopic properties, density, water content, and others. Reaction conversion and purity may be determined via several methods, either in-situ or ex-situ, including Karl Fischer titration, conductivity measurement, Fourier-transform infrared spectroscopy, Raman spectroscopy, nuclear magnetic resonance, gas chromatography, liquid chromatography, spectroscopy, thermogravimetric analysis, calorimetry, inductively coupled plasma mass spectrometry, and others.

The electrolyte and method for production detailed herein overcomes the challenges set forth in the Background by removing, or reducing, the content of DME contained in electrolytes containing lithium or sodium borate esters. The technology described herein offers a range of compelling advantages, including, but not necessarily limited to:
Manufacturing cost reduction: The removal of the need for drying steps following salt synthesis reduces manufacturing costs by reducing both capital and operating costs associated with electrolyte manufacturing.
Improved purity: The removal of DME as an adduct with borate ester salts improves electrolyte properties and performance. DME is volatile, flammable, and suffers from poor oxidative stability. The removal, or reduction, of this molecule from fabricated electrolytes can increase performance.

These and other aspects of the technology described herein will be apparent after consideration of the Detailed Description and Figures herein.

### DESCRIPTION OF THE DRAWINGS

FIG. 1 depicts the block flow reaction diagram for the method of producing a lithium borate ester electrolyte, not containing 1,2-dimethoxyethane (DME).

FIG. 2 depicts the block flow reaction diagram for the method of producing a sodium borate ester electrolyte, not containing 1,2-dimethoxyethane (DME).

FIG. 3 depicts a diagram of a batch reactor to produce the described sodium borate ester electrolyte, without contamination by 1,2-dimethoxyethane (DME). In this exemplary, though non-limiting, embodiment, an alcohol with the formula ROH is used as the acidic precursor for the reaction.

FIG. 4 shows images of A) 2 mL samples of a baseline PC:DEC solvent blend, a PC:DEC solvent with 1M NaBH₄ added, which is minimally soluble in the solvent, and an electrolyte containing 1M NaB(hfip)₄ (i.e., NaBhfip; sodium tetra(hexafluoro isopropoxy)borate) in the same PC:DEC solvent blend, synthesized via an exemplary method of this disclosure. The 1M NaBhfip electrolyte in 40:60 wt % propylene carbonate (PC):diethyl carbonate (DEC) solvent is fully dissolved, indicating the high conversion of the minimally soluble NaBH₄ precursor to the soluble NaBhfip product. B) Image of a 50 mL batch containing 1M NaBhfip in a PC:DEC solvent blend, indicating the scalability of the methods of this disclosure.

FIG. 5 shows the conductivity (in mS/cm) of A) a baseline PC:DEC solvent blend without DME, B) a conventionally synthesized electrolyte containing 1M NaBhfip(DME) in the same PC:DEC solvent blend, C) an electrolyte containing 1M NaBhfip in the same PC:DEC solvent blend without DME contamination, synthesized via the claimed method, and D) an electrolyte containing 1M NaBH₄ in the same PC:DEC blend. Note that the 1M NaBH₄ is not fully dissolved. The similar conductivity of the two NaBhfip electrolytes, which are substantially higher (>30×) than the NaBH₄ reference, indicates the high degree of conversion of NaBH₄ to NaBhfip using the new claimed method.

FIG. 6, panels A-C, show Panel A) FTIR (Fourier transform infrared spectroscopy) spectrums for a baseline DME solvent, a baseline PC:DEC solvent blend without DME, a conventionally synthesized electrolyte containing 1M NaBhfip(DME) in the same PC:DEC solvent blend, and an electrolyte containing 1M NaBhfip in the same PC:DEC solvent blend without DME contamination, synthesized via the methods of this disclosure. NaBhfip(DME) was produced as a dried salt using the conventional method, and contains DME adducted to the salt in its dried form, which ultimately contaminates the electrolyte. Panel B) and Panel C) show highlighted FTIR regions, where additional peaks are observed for the conventionally-produced NaBhfip(DME) electrolyte that do not exist in the NaBhfip electrolyte produced via the new method. These additional peaks match those in the DME reference spectra (emphasized with arrows), indicating that they arise from DME contamination, which is not observed in the electrolyte produced via the methods of this disclosure.

FIG. 7 shows the cycling performance of a state-of-the-art electrolyte with 1M NaPF₆ in a PC:DEC solvent blend, where all components are battery grade, versus a 1M NaBhfip electrolyte in the same PC:DEC solvent blend, produced via the methods of this disclosure without DME contamination. Both electrolytes are studied in coin full-cells, with a hard carbon anode and transition metal oxide cathode, having a commercially-relevant areal capacity of 2.8 mAh/cm². The darker, star points indicate C/10 cycles, and the lighter circles indicate 1C cycles, both normalized to the first cycle at the respective C-rate to show capacity retention. The NaBhfip electrolyte produced via the methods of this disclosure without DME impurity substantially outcompetes the state-of-the-art NaPF₆ electrolyte, having lost only 15% of its original capacity after 500 cycles, versus a 27% loss in the NaPF₆ electrolyte. Both have similar initial discharge capacities within 10% of each other.

FIG. 8 shows the Coulombic efficiency (CE) of a state-of-the-art electrolyte with 1M NaPF in a PC:DEC solvent blend, where all components are battery grade, versus a 1M NaBhfip electrolyte in the same PC:DEC solvent blend, produced via the methods of this disclosure without DME contamination. The electrodes and cells are the same as those shown in FIG. 7. The 1M NaBhfip electrolyte synthesized with the new method achieves high CE.

FIG. 9 shows the average Coulombic efficiency (CE) of a state-of-the-art electrolyte with 1M NaPF₆ in a PC:DEC solvent blend, where all components are battery grade, versus a 1M NaBhfip electrolyte in the same PC:DEC solvent blend, produced via the methods of this disclosure without DME contamination. CE values are averaged over the preceding 10 cycles. The electrodes and cells are the same as those shown in FIG. 7. The 1M NaBhfip electrolyte synthesized with the new method achieves a higher average CE than the state-of-the-art NaPF₆ electrolyte, and has higher average CE in early cycling. The 1M NaBhfip electrolyte synthesized with the new method reaches an average CE that is consistently >99.95% in full cells. Note that CE spikes every 100 cycles due to the low-rate C/20 cycles, which shift the average of the following 10 cycles.

FIG. 10, panels A-B, show the charge and discharge voltage profiles at cycle 1 (panel A) and cycle 501 (panel B) for coin full cell batteries with a state-of-the-art electrolyte with 1M NaPF₆ in a PC:DEC solvent blend, where all components are battery grade, versus a 1M NaBhfip electrolyte in the same PC:DEC solvent blend, produced via the methods of this disclosure without DME contamination. Both electrolytes are studied in coin full-cells, with a hard carbon anode and transition metal oxide cathode, having a commercially-relevant areal capacity of 2.8 mAh/cm². The 1M NaBhfip electrolyte synthesized with the new method achieves a higher discharge capacity at cycle 501 (panel B) than a state-of-the-art NaPF₆ electrolyte.

FIG. 11 shows the voltage profile evolution over 500 cycles for a coin full cell battery with a 1M NaBhfip electrolyte in a PC:DEC solvent blend, produced via the methods of this disclosure without DME contamination. The battery exhibits excellent capacity retention.

FIG. 12 shows the cycling performance of a state-of-the-art electrolyte with 1M NaPF₆ in a PC:EMC solvent blend, where all components are battery grade. Two electrolytes are shown with 1M NaBhfip in the same 30:70 wt % propylene carbonate (PC):ethyl methyl carbonate (EMC) solvent blend, one without additives, and one with 1 wt % of sodium difluoro(oxalate)borate (NaDFOB). Both NaBhfip(DME) electrolytes are produced via the standard synthetic method and thus include DME. Cycle life is shown for coin full-cells, with a hard carbon anode and transition metal oxide cathode (NFM, NaNi_{1/3}Fe_{1/3}Mn_{1/3}O₂), having a commercially-relevant areal capacity of 2.3 mAh/cm². The first-cycle is performed at C/20, with C/20 check-ups every 50 cycles; intermediate cycles are performed at 1C with a 3.8V cutoff. The electrolyte with NaDFOB additive provides improved discharge capacity and capacity retention.

FIG. 13 shows the average Coulombic efficiency (CE) of a state-of-the-art electrolyte with 1M NaPF₆ in a PC:EMC solvent blend, where all components are battery grade. Two electrolytes are shown with 1M NaBhfip in the same PC:EMC solvent blend, one without additives, and one with 1 wt % of sodium difluoro(oxalate)borate (NaDFOB). Both NaBhfip(DME) electrolytes are produced via the standard synthetic method and thus include DME. CE values are averaged over the preceding 10 cycles. The electrodes and cells are the same as those shown in FIG. 12. The electrolyte containing NaDFOB further improves CE over the standard NaBhfip(DME), both of which are superior to the NaPF₆ electrolyte. The average CE drops every 50 cycles following the low-rate C/20 cycles.

### DETAILED DESCRIPTION

Embodiments are described more fully below with reference to the accompanying Figures, which form a part hereof and show, by way of illustration, specific exemplary embodiments. However, embodiments may be implemented in many different forms and should not be construed as being limited to the embodiments set forth herein. The following detailed description is, therefore, not to be taken in a limiting sense.

Described herein are electrolyte compositions having suitability for use in sodium-based batteries. As used herein, the term sodium-based battery is intended to encompass all types of batteries incorporating sodium material in the cell architecture, such as the use of sodium as a material in the electrodes. Sodium-based batteries may include, but are not necessarily limited to, sodium batteries, sodium-ion batteries, sodium metal batteries, and anode-free sodium batteries. In some embodiments, the electrolyte compositions described herein include at least one sodium borate ester salt, and are therefore well suited for use in sodium-based batteries. As used herein, the term anode-free substrate refers to an anode material that is designed for metal (e.g., Na metal, Li metal) deposition onto the surface of the substrate during charging of the battery.

Described herein are electrolyte compositions having suitability for use in lithium-based batteries. As used herein, the term lithium-based battery is intended to encompass all types of batteries incorporating lithium material in the cell architecture, such as the use of lithium as a material in the electrodes. Lithium-based batteries may include, but are not necessarily limited to, lithium batteries, lithium-ion batteries, lithium metal batteries, and anode-free lithium batteries. In some embodiments, the electrolyte compositions described herein include at least one lithium borate ester salt, and are therefore well suited for use in lithium-based batteries.

In some embodiments, the electrolyte composition generally includes at least one sodium borate salt. The sodium borate salt may have the formula NaB(OR)₄. In exemplary, though non-limiting, sodium borate esters, four ligands (i.e., OR groups) are bonded to a central boron atom.

In some embodiments, the sodium borate ester salt has the formula:

NaB(OR)₄
wherein:
   each R is independently selected from alkyl, substituted alkyl, carboxyl group, alkyl-C(═O)—, substituted alkyl-C(═O)—, phenyl, substituted phenyl, silyl group, sulfonyl group, and a nitrile group.

In exemplary, though non-limiting, sodium borate esters, R is selected from an alkyl group, a fluoroalkyl group, a cyano-alkyl group, a functionalized alkyl group, a carboxyl group, a fluoro-carboxyl group, a functionalized carboxyl group, a phenyl group, a fluoro-phenyl group, a functionalized phenyl group, a sulfonyl group, a silyl group, and a nitrile group. While the composition may, in some embodiments, include one sodium borate ester salt and one solvent, other embodiments of the electrolyte composition may include multiple different types of sodium borate ester salts and/or solvents. For example, the electrolyte composition described herein may include two different sodium borate ester salts and one solvent, one sodium borate ester salt and two different solvents, two different sodium borate ester salts and two different solvents, etc.

With respect to the formula NaB(OR)₄, exemplary, though non-limiting, sodium borate ester salts having the formula NaB(OR)₄ that are suitable for use in the electrolyte compositions described herein include sodium tetra(hexafluoro isopropoxy)borate, sodium tetra(1,1,1-trifluoro isopropoxy)borate, sodium tetra(2-trifluoromethyl isopropoxy)borate, sodium tetra(trifluoro ethoxy)borate, sodium tetra(difluoro ethoxy)borate, sodium bis(perfluoro pinacolato)borate, sodium tetra(pentafluoro phenoxy)borate, sodium tetra(perfluoro tertbutoxy)borate, sodium tetra(trifluoro acetoxy)borate, sodium tetra(3-methylphenoxy)borate, sodium tetra(4-methylphenoxy)borate, sodium tetra(2-fluoro-3-methylphenoxy)borate, sodium tetra(4-fluoro-3-methylphenoxy)borate, sodium tetra(2-fluoro-5-methylphenoxy)borate, sodium tetra(4-cyano phenoxy)borate, sodium tetra(3-cyano phenoxy)borate, sodium tetra(3,4-dicyano phenoxy)borate, sodium tetra(3,5-dicyano phenoxy)borate, sodium tetra(3-cyano-5-fluoro phenoxy)borate, sodium tetra(1-phenyl-2,2,2-trifluoro ethoxy)borate, sodium tetra(1-cyano-2,2,2-trifluoro ethoxy)borate, sodium tetra(1,1,1-trifluoro-2-cyano isopropoxy)borate, sodium tetra(2-cyano isopropoxy)borate, sodium tetra(1-cyano isopropoxy)borate, sodium tetra(2-cyano ethoxy)borate, sodium tetra(1-cyano-1-methoxy methoxy)borate, sodium tetra(1-cyano-1-ethoxy methoxy)borate, sodium tetra(1-cyano-1-phenyl methoxy)borate, sodium tetra(2-cyano-1-methoxy ethoxy)borate, sodium tetra(2-cyano-1-ethoxy ethoxy)borate, sodium tetra(methysulfonyl)borate, sodium tetra(trifluoromethysulfonyl)borate, and sodium tetra(trimethylsilyl)borate.

In some embodiments, the total amount of sodium borate ester salt in the electrolyte composition, whether based on one type of sodium borate ester salt or multiple types of sodium borate ester salts that may be used in the composition, is generally in the range of from about 0.1 mol/L to 5 mol/L of the electrolyte composition, or 3% to 70% of the total electrolyte mass.

In some embodiments, the electrolyte composition generally includes at least one lithium borate salt. The lithium borate salt may have the formula LiB(OR)₄. In some embodiments, each R is independently selected from alkyl, substituted alkyl, carboxyl group, alkyl-C(═O)—, substituted alkyl-C(═O)—, phenyl, substituted phenyl, silyl group, sulfonyl group, and a nitrile group. In exemplary, though non-limiting, lithium borate esters, four ligands (i.e., OR groups) are bonded to a central boron atom. In exemplary, though non-limiting, lithium borate esters, R is selected from an alkyl group, a fluoroalkyl group, a cyano-alkyl group, a functionalized alkyl group, a carboxyl group, a fluoro-carboxyl group, a functionalized carboxyl group, a phenyl group, a fluoro-phenyl group, a functionalized phenyl group, a sulfonyl group, a silyl group, and a nitrile group. While the composition may, in some embodiments, include one lithium borate ester salt and one solvent, other embodiments of the electrolyte composition may include multiple different types of lithium borate ester salts and/or solvents. For example, the electrolyte composition described herein may include two different lithium borate ester salts and one solvent, one lithium borate ester salt and two different solvents, two different lithium borate ester salts and two different solvents, etc.

With respect to the formula LiB(OR)₄, exemplary, though non-limiting, lithium borate ester salts having the formula LiB(OR)₄ that are suitable for use in the electrolyte compositions described herein include lithium tetra(hexafluoro isopropoxy)borate, lithium tetra(1,1,1-trifluoro isopropoxy)borate, lithium tetra(2-trifluoromethyl isopropoxy)borate, lithium tetra(trifluoro ethoxy)borate, lithium tetra(difluoro ethoxy)borate, lithium bis(perfluoro pinacolato)borate, lithium tetra(pentafluoro phenoxy)borate, lithium tetra(perfluoro tertbutoxy)borate, lithium tetra(trifluoro acetoxy)borate, lithium tetra(3-methylphenoxy)borate, lithium tetra(4-methylphenoxy)borate, lithium tetra(2-fluoro-3-methylphenoxy)borate, lithium tetra(4-fluoro-3-methylphenoxy)borate, lithium tetra(2-fluoro-5-methylphenoxy)borate, lithium tetra(4-cyano phenoxy)borate, lithium tetra(3-cyano phenoxy)borate, lithium tetra(3,4-dicyano phenoxy)borate, lithium tetra(3,5-dicyano phenoxy)borate, lithium tetra(3-cyano-5-fluoro phenoxy)borate, lithium tetra(1-phenyl-2,2,2-trifluoro ethoxy)borate, lithium tetra(1-cyano-2,2,2-trifluoro ethoxy)borate, lithium tetra(1,1,1-trifluoro-2-cyano isopropoxy)borate, lithium tetra(2-cyano isopropoxy)borate, lithium tetra(1-cyano isopropoxy)borate, lithium tetra(2-cyano ethoxy)borate, lithium tetra(1-cyano-1-methoxy methoxy)borate, lithium tetra(1-cyano-1-ethoxy methoxy)borate, lithium tetra(1-cyano-1-phenyl methoxy)borate, lithium tetra(2-cyano-1-methoxy ethoxy)borate, lithium tetra(2-cyano-1-ethoxy ethoxy)borate, lithium tetra(methysulfonyl)borate, lithium tetra(trifluoromethysulfonyl)borate, and lithium tetra(trimethylsilyl)borate.

In some embodiments, the total amount of lithium borate ester salt in the electrolyte composition, whether based on one type of lithium borate ester salt or multiple types of lithium borate ester salts that may be used in the composition, is generally in the range of from about 0.1 mol/L to 5 mol/L of the electrolyte composition, such as from 0.3 mol/L to 5 mol/L, or from 0.8 mol/L to 1.5 mol/L. In some embodiments, the electrolyte composition includes 3% to 70% by weight of the lithium borate ester salt(s), such as 5% to 50% by weight, or 10% to 40% by weight.

In some embodiments, the electrolyte composition generally includes at least one solvent that does not have the composition 1,2-dimethoxyethane (i.e., DME, monoglyme). The solvent may be selected from an ether solvent, an ester solvent, a carbonate solvent, a fluoro-ether solvent, a phosphate solvent, a phosphite solvent, a fluoro-ester solvent, an anhydride solvent, an amide solvent, a cyclic-ether solvent, a cyclic-ester solvent, a cyclic-sulfate solvent, a cyclic-carbonate solvent, a nitrile solvent, a cyclic-phosphate solvent, a sulfate solvent, a sulfone solvent, and a sultone solvent. While the composition may, in some embodiments, include one solvent, other embodiments of the electrolyte composition may include multiple different types of solvents that are not 1,2-dimethoxyethane. For example, the electrolyte composition described herein may include two different solvents, or three different solvents.

In some embodiments, the electrolyte composition includes ≥92 wt % of a solvent, or multiple solvents, that are not 1,2-dimethoxyethane. That is to say, exemplary, though non-limiting, electrolytes contain <8 wt % of 1,2-dimethoxyethane, such as <7 wt %, <6 wt %, <5 wt %, <4 wt %, <3 wt %, <2 wt %, or <1 wt % of 1,2-dimethoxyethane. In some embodiments, the electrolyte composition includes at least 0.5M of the lithium borate ester salt(s), such as at least 1.0M, at least 1.5M, or 0.5M to 2.0M lithium borate ester salt(s). In some embodiments, the electrolyte composition includes at least 0.5M of the sodium borate ester salt(s), such as at least 1.0M, at least 1.5M, or 0.5M to 2.0M sodium borate ester salt(s).

Exemplary, though non-limiting, electrolyte compositions generally contain substantially no, or no 1,2-dimethoxyethane, wherein 100 wt % of the solvent is comprised of a solvent, or multiple different solvents, that are not 1,2-dimethoxyethane. In some embodiments, the liquid solvent comprises a carbonate solvent, a cyclic-carbonate solvent, or a combination thereof.

Exemplary, though non-limiting, solvents that are suitable for use in the electrolyte compositions described herein are non-aqueous. In some embodiments, the at least one solvent is selected from diethylene glycol dimethyl ether (diglyme), triethylene glycol dimethyl ether (triglyme), tetraethylene glycol dimethyl ether (tetraglyme), dimethyl carbonate, diethyl carbonate, ethyl methyl carbonate, ethylene carbonate, propylene carbonate, triethyl phosphate, trimethyl phosphate, triethyl phosphite, trimethyl phosphite, fluoroethylene carbonate, ethyl butyrate, gamma-butyrolactone, gamma-valerolactone, triacetin, tetrahydrofuran, 1,3-dioxolane, 1,3-dioxane, 1,4-dioxane, acetic anhydride, N, N-dimethylformamide, dimethyl maleate, diethyl maleate, diallyl maleate, dimethyl malonate, diethyl malonate, dimethyl oxalate, diethyl oxalate, anisole, ethyl phenyl ether, methoxy perfluorobutane, methoxy perfluoropropane, ethoxy perfluorobutane, ethoxy perfluoropropane, diethyl ether, dipropyl ether, dibutyl ether, ethylene glycol diethyl ether, ethylene glycol dipropyl ether, ethylene glycol dibutyl ether, diethoxymethane (ethylal), 1,1-diethoxyethane, diethylene glycol divinyl ether, triethyl orthoformate, 1,1,1-triethoxyethane, 1,1,1-triethoxypropane, sulfolane, 3-methyl sulfolane, sulfolene, 1,3-propane sultone, 1,4-butane sultone, 1,3,2-dioxathiolane 2,2-dioxide, 1,3,2-dioxathiane 2,2-dioxide, tetramethylene sulfoxide, 2,2-dimethoxypropane, butyric anhydride, isobutyric anhydride, 1,1,2,2-tetrafluoroethyl-2,2,3,3-tetrafluoropropyl ether, perfluoro- 15-crown-5-ether, 1,1,3,3,3-pentafluoro-2-trifluoromethylpropyl methyl ether, 1,1,2,2-tetrafluoroethyl 2,2,2-trifluoroethyl ether, methyl(2,2,2-trifluoroethyl)carbonate, 2,2,3,3,3-pentafluoropropyl-1,1,2,2-tetrafluoro-ethyl ether, fluorinated triethylene glycol monobutyl ether, (trifluoromethoxy)benzene, 4-toluene trifluoromethyl ether, bis-(4-fluorophenyl) ether, bis-(4-trifluoromethylphenyl) ether, 1,1,2,3,3,3-hexafluoropropyl methyl ether, 1,1,2,3,3,3-hexafluoropropyl ethyl ether, 1,1,2,3,3,3-hexafluoropropyl propyl ether, 1,1,2,3,3,3-hexafluoropropyl butyl ether, hexafluoroisopropyl methyl ether, hexafluoroisopropyl ethyl ether, hexafluoroisopropyl propyl ether, hexafluoroisopropyl isopropyl ether, hexafluoroisopropyl butyl ether, trifluoroethyl methyl ether, trifluoroethyl ethyl ether, trifluoroethyl propyl ether, trifluoroethyl butyl ether, 2,2,2-trifluoroethyl acetate, ethyl trifluoroacetate, propyl trifluoroacetate, isopropyl trifluoroacetate, butyl trifluoroacetate, 2,2,2-trifluoroethyl difluoromethyl ether, methyl cyanoformate, ethyl cyanoformate, methoxyacetonitrile, ethoxyacetonitrile, 2-phenoxyacetonitrile, methylsulfonylacetonitrile, tris(2,2,2-trifluoroethyl) phosphite, tris(2,2,2-trifluoroethyl) phosphate, dimethyl sulfate, diethyl sulfate, dimethyl sulfone, diethyl sulfone, divinyl sulfone, dipropyl sulfone, and dibutyl sulfone.

The total amount of solvent in the electrolyte composition, whether based on one type or species of solvent or multiple types or species of solvents that may be used in the composition, is generally in the range of from about 1 wt % to about 99 wt % of the electrolyte composition. That is to say, when an electrolyte composition includes more than one type or species of solvent, the sum of the content of the multiple solvents present in the electrolyte composition is within the range of from 1 wt % to 99 wt %.

While the core components of the electrolyte composition, in some embodiments, are one or more sodium borate ester salts and one or more solvents, the electrolyte composition may include other materials as well. In some embodiments, the electrolyte composition may also include one or more supplemental salts and/or one or more additives. These components may be present in the electrolyte composition in any suitable amount, though in some embodiments, these materials may be present at a wt % that is less than the amount of sodium borate ester salts and primary solvents used in the electrolyte composition.

While the core components of the electrolyte composition, in some embodiments, are one or more lithium borate ester salts and one or more solvents, the electrolyte composition may include other materials as well. In some embodiments, the electrolyte composition may also include one or more supplemental salts and/or one or more additives. These components may be present in the electrolyte composition in any suitable amount, though in some embodiments, these materials may be present at a wt % that is less than the amount of lithium borate ester salts and primary solvents used in the electrolyte composition.

With respect to supplemental salts for electrolytes comprising a sodium borate ester salt, the electrolyte composition can include as supplemental salts any salt that are non-sodium borate ester salts, and which do not prevent the electrolyte composition from functioning in the sodium-based battery. Exemplary, though non-limiting, supplemental salts that can be used in the electrolyte composition include sodium hexafluorophosphate, sodium tetrafluoroborate, sodium perchlorate, sodium bis(oxalato)borate, sodium difluoro(oxalato)borate, sodium (trifluoromethane sulfonyl)imide, sodium bis(fluoro sulfonyl)imide, sodium trifluoroacetate, sodium heptafluorobutyrate, sodium pentafluoropropionate, sodium trifluoromethanesulfonate, sodium fluorosulfate, sodium nitrate, sodium difluoro(bisoxalato)phosphate, sodium difluorophosphate, sodium methanesulfonate, sodium sulfamate, sodium naphthalene-2-sulfonate, sodium bis(trimethylsilyl)amide, sodium trimethylsilanolate, sodium bis(malato)borate, and sodium difluoro(malato)borate. In some embodiments, the supplemental salt may comprise a lesser wt % of the electrolyte than the sodium borate ester salt. In other embodiments, the supplemental salt may comprise a greater wt % of the electrolyte than the sodium borate ester salt.

With respect to supplemental salts for electrolytes comprising a lithium borate ester salt, the electrolyte composition can include as supplemental salts any salt that are non-lithium borate ester salts, and which do not prevent the electrolyte composition from functioning in the lithium-based battery. Exemplary, though non-limiting, supplemental salts that can be used in the electrolyte composition include lithium hexafluorophosphate, lithium tetrafluoroborate, lithium perchlorate, lithium bis(oxalato)borate, lithium difluoro(oxalato)borate, lithium (trifluoromethane sulfonyl)imide, lithium bis(fluoro sulfonyl)imide, lithium trifluoroacetate, lithium heptafluorobutyrate, lithium pentafluoropropionate, lithium trifluoromethanesulfonate, lithium fluorosulfate, lithium nitrate, lithium difluoro(bisoxalato)phosphate, lithium difluorophosphate, lithium methanesulfonate, lithium sulfamate, lithium naphthalene-2-sulfonate, lithium bis(trimethylsilyl)amide, lithium trimethylsilanolate, lithium bis(malato)borate, and lithium difluoro(malato)borate. In some embodiments, the supplemental salt may comprise a lesser wt % of the electrolyte than the lithium borate ester salt. In other embodiments, the supplemental salt may comprise a greater wt % of the electrolyte than the lithium borate ester salt.

With respect to additives, any suitable additive can be used, provided that the additives do not prevent the electrolyte composition from functioning in the battery. Exemplary, though non-limiting, additives that can be used in the electrolyte composition include vinyl carbonate, vinylene carbonate, fluoroethylene carbonate, 1,3-propane sultone, 1,4-butane sultone, 1,3,2-dioxathiolane 2,2-dioxide, thiophene, sodium difluoro(bisoxalato) phosphate, sodium difluorophosphate, sodium bis(oxalato)borate, sodium difluoro(oxalato)borate, trimethyl phosphite, tris(trimethylsilyl)phosphite, trimethyl borate, sodium tetra(methyl)borate, triethyl borate, tris(trimethylsilyl)borate, biphenyl, boron trifluoride, maleic anhydride, succinic anhydride, itaconic anhydride, trifluoroacetic anhydride, trifluoromethanesulfonic anhydride, trimethylboroxine, trihydroxybenzene, succinimide, lithium nitrate, diethyl pyrocarbonate, vinyl acetate, trimethyl(trifluoromethyl)silane, aluminum ethoxide, titanium isopropoxide, lithium difluoro(bisoxalato)phosphate, lithium difluorophosphate, lithium bis(oxalato)borate, and lithium difluoro(oxalato)borate.

In some embodiments, the battery is a sodium-based battery, and the anode (i.e., negative electrode) is selected from hard carbon, sodium metal, aluminum foil, graphite, other carbon-based materials, tin, lead, or a combination thereof. In some embodiments, the battery is a lithium-based battery, and the anode is selected from graphite, lithium metal, aluminum foil, copper foil, silicon, other carbon-based materials, or a combination thereof.

In some embodiments, the battery is a sodium-based battery and the cathode (i.e., positive electrode) is composed of a material selected from: sodium nickel-iron-manganese oxide (NFM, e.g., NaNiₓFe_{y}Mn_{z}O₂, where x+y+z=1), sodium transition metal oxide (e.g., NaₓTMO₂ wherein TM =a transition metal, Fe, Mn, Ni, Co, Cr, Ti, V, or combination thereof; x>0 and ≤1), NaₐNi_{1-x-y-z}MnₓMg_{y}Ti_{z}O₂ (a>0 and ≤1; x+y+z=1), sodium copper-iron-manganese oxide (NaₐCuₓFe_{y}Mn_{z}O₂, where a>0 and ≤1; x+y+z=1), sodium ferric phosphate pyrophosphate (NFPP, Na₄Fe₃(PO₄)₂(P₂O₇)), Na₃V₂PO₄, sodium chromium oxide (NaCrO₂), potassium-doped sodium manganese oxide (NaₐK_{b}MnO₂, where a+b≤1), Prussian White (NaₐFeMn(CN)₆, where a>0 and ≤2), Prussian Blue (NaₐFe₂(CN)₆, where a>0 and ≤2), a metal phosphate, pyrophosphate, or diphosphate (e.g., including Fe, Mn, V, Ti, or a combination thereof), a metal sulfide (e.g., sodium sulfide), or a combination thereof.

In some embodiments, the battery is a lithium-based battery and the cathode is composed of a material selected from: a metal oxide having the general formula LiₓMO₂, where x is >0 and ≤1, containing, but not limited to, Ni, Fe, Mn, Co, Al, or a combination thereof, a metal phosphate, pyrophosphate, or diphosphate containing, but not limited to, Fe, Mn, V, Ti, or a combination thereof, a metal sulfide, lithium sulfide, lithium nickel-manganese-cobalt oxide (NMC, LiNiₓMn_{y}Co_{z}O₂, where x+y+z=1), lithium nickel-cobalt-aluminum oxide (NCA, LiNiₓCo_{y}Al_{z}O₂, where x+y+z=1), lithium iron phosphate (LFP, LiFePO₄), and lithium iron manganese phosphate (LMFP, LiMnₓFe_{y}PO₄, where x+y=1).

In exemplary, though non-limiting, cases the battery further comprises a separator between the anode and cathode that is wetted by the liquid electrolyte. In some embodiments, the separator is a polymer separator that may be selected from the set containing polyethylene, polypropylene, cellulose, polyethylene terephthalate, glass microfiber, poly(vinylidene fluoride), and a combination thereof. In some embodiments, the separator may be further coated with a ceramic coating.

With respect to the electrolyte, an exemplary, though non-limiting, electrolyte for sodium-based batteries has a composition that is comprised of sodium tetra(hexafluoro isopropoxy)borate in a carbonate solvent, where the salt and solvent comprise approximately 40% and 60% of the total electrolyte mass, respectively. In some embodiments, this exemplary electrolyte does not include 1,2-dimethoxyethane. That is to say, in some embodiments, 100 wt % of the solvent is comprised of carbonate solvents. Exemplary, though non-limiting, carbonate solvents are generally comprised of a cyclic carbonate and a linear carbonate. Exemplary, though non-limiting cyclic carbonates include ethylene carbonate, propylene carbonate, and fluoroethylene carbonate. Exemplary, though non-limiting linear carbonates include dimethyl carbonate, diethyl carbonate, and ethyl methyl carbonate.

With respect to the electrolyte, an exemplary, though non-limiting, electrolyte for lithium-based batteries has a composition that is comprised of lithium tetra(hexafluoro isopropoxy)borate in a carbonate solvent, where the salt and solvent comprise approximately 40% and 60% of the total electrolyte mass, respectively. In some embodiments, this exemplary electrolyte does not include 1,2-dimethoxyethane. That is to say, in some embodiments, 100 wt % of the solvent is comprised of carbonate solvents. Exemplary, though non-limiting, carbonate solvents are generally comprised of a cyclic carbonate and a linear carbonate. Exemplary, though non-limiting cyclic carbonates include ethylene carbonate, propylene carbonate, and fluoroethylene carbonate. Exemplary, though non-limiting linear carbonates include dimethyl carbonate, diethyl carbonate, and ethyl methyl carbonate.

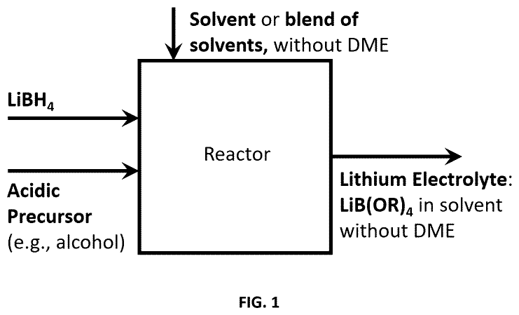

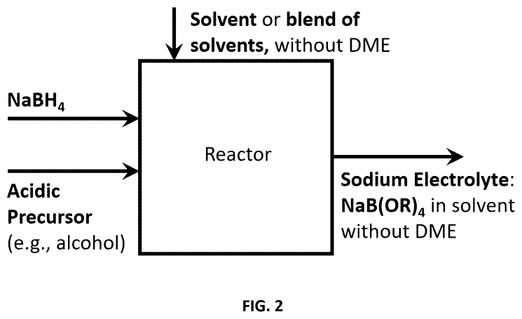

Methods of making the electrolyte compositions described herein are also part of the present disclosure. FIGS. 1 and 2 generally outline the two similar approaches to making the electrolyte compositions described herein.

With respect to FIG. 1, an exemplary, though non-limiting, approach is provided for making electrolytes that comprise a lithium borate ester salt for use in lithium-based batteries. This approach generally includes the step of combining lithium borohydride, a solvent, and an acidic precursor. When combined, a reaction between the lithium borohydride and the acidic precursor leads to the formation of a lithium borate ester salt. In exemplary, though non-limiting, embodiments, the lithium borate ester salt is dissolved in the solvent following the reaction, and may be used as an electrolyte in lithium-based batteries. The specific order in which the lithium borohydride, the solvent, and the acidic precursor are combined is generally not limited. While in some embodiments a batch reaction process may be used, in other embodiments the reaction may take place in a continuous configuration.

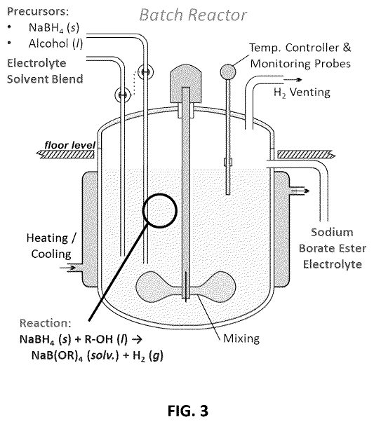

With respect to FIG. 2, an exemplary, though non-limiting, approach is provided for making electrolytes that comprise a sodium borate ester salt for use in sodium-based batteries. This approach generally includes the step of combining sodium borohydride, a solvent, and an acidic precursor. When combined, a reaction between the sodium borohydride and the acidic precursor leads to the formation of a sodium borate ester salt. In exemplary, though non-limiting, embodiments, the sodium borate ester salt is dissolved in the solvent following the reaction, and may be used as an electrolyte in sodium-based batteries. The specific order in which the sodium borohydride, the solvent, and the acidic precursor are combined is generally not limited. While in some embodiments a batch reaction process may be used, in other embodiments the reaction may take place in a continuous configuration. FIG. 3 exhibits an exemplary, though non-limiting reactor configuration.

With respect to acidic precursors, any suitable acidic precursor can be used, provided that it reacts with the borohydride to form a borate ester. Exemplary, though non-limiting, acidic precursors that can be reacted with the borohydride include hexafluoro-2-propanol, 2,2,2-trifluoroethanol, phenol, 1,1,1-trifluoroisopropanol, 2,2-difluoroethanol, pentafluoro phenol, perfluoro tert-butanol, trifluoro acetic acid, acetic acid, 3-methyl phenol, 4-methyl phenol, 2-fluoro-3-methyl phenol, 4-fluoro-3-methyl phenol, 4-cyano phenol, 3-cyano phenol, 3,4-dicyano phenol, 3,5-dicyano phenol, 3-cyano-5-fluoro phenol, 1-phenyl-2,2,2-trifluoro ethanol, 1-cyano-2,2,2-trifluoro ethanol, 1,1,1-trifluoro-2-cyano isopropanol, acetone cyanohydrin, trifluoroacetone cyanohydrin, 1-cyano isopropanol, 2-cyano ethanol, methanesulfonic acid, trifluoromethanesulfonic acid, fluorosulfonic acid, cyanic acid, and trimethylsilanol.

In some embodiments, the acidic precursor is reacted with sodium borohydride to yield a sodium borate ester salt. In other embodiments, the acidic precursor is reacted with lithium borohydride to yield a lithium borate ester salt.

While in some embodiments, a single acidic precursor is reacted with the borohydride to yield an electrolyte comprising a single borate ester salt, in other embodiments, multiple different types of acidic precursors may be reacted with the borohydride to yield an electrolyte comprising multiple different borate ester salts.

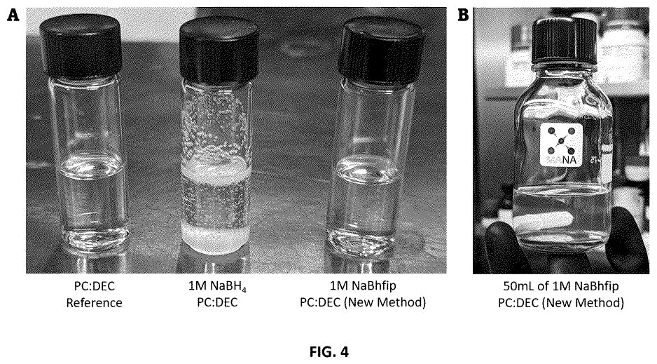

With respect to FIG. 4, the exemplary, though non-limiting, electrolyte of [0058] is shown to be fully dissolved and synthesized in both small (2 mL) and large (50 mL) batches. These batch sizes are examples of the scalable nature of the method, and are taken to be non-limiting in nature. FIG. 4A also exhibits a solution of NaBH₄ in carbonate solvent, after sitting for 24 hours. The NaBH₄ has dissolved minimally in the carbonate solvent, due to its low solubility, which serves to demonstrate the high degree of conversion of the NaBH₄ to the electrolyte of [0058], following the addition of the acidic precursor and the subsequent reaction.

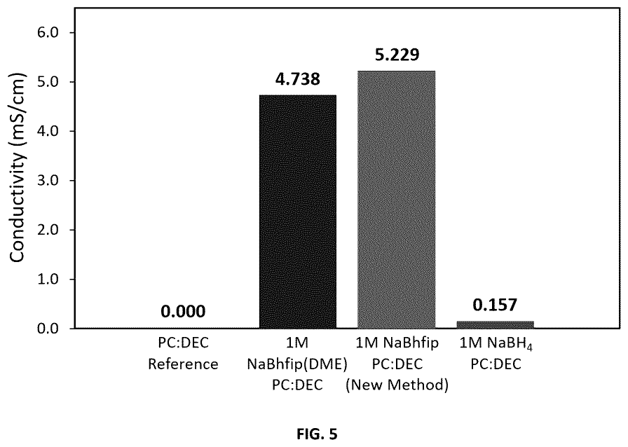

With respect to FIG. 5, conductivities of multiple electrolytes are shown. The base carbonate solvent has no ionic conductivity as there are no dissolved salts. The reference solution of 1M NaBH₄ in carbonate solvent also has very low conductivity, because the NaBH₄ is minimally dissolved. Both of the electrolytes containing a sodium borate ester have high ionic conductivity. The electrolyte of [0058], comprising 1M sodium tetra(hexafluoro isopropoxy)borate (i.e., NaBhfip) in carbonate has higher conductivity than the electrolyte containing 1M NaBhfip(DME) in carbonate, where the NaBhfip(DME) salt is synthesized in the conventional manner with 1,2-dimethoxyethane (DME) solvent, which is vacuum dried to yield the NaBhfip(DME) salt that has 1 molecule of DME adducted to every 1 molecule of salt. The NaBhfip electrolyte has higher ionic conductivity than the NaBhfip(DME) electrolyte due to the removal of DME, which lowers the wt % of carbonate solvent and the wt % of the borate ester salt relative to the total mass of the electrolyte.

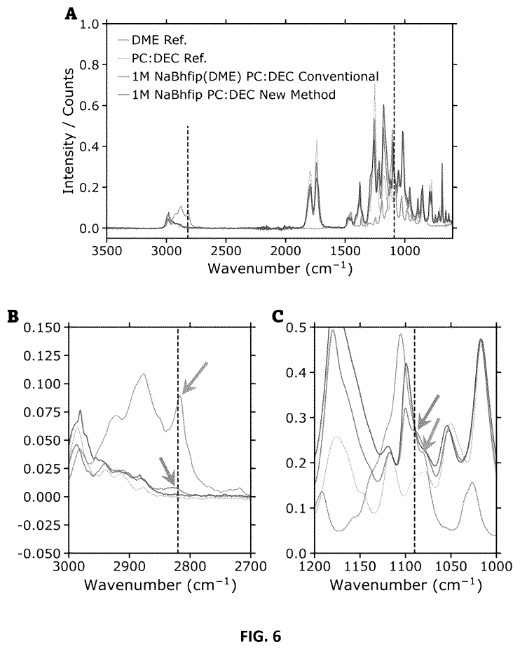

With respect to FIG. 6, Fourier-transform infrared spectroscopy spectrums are shown for a DME reference, a carbonate reference, the electrolyte e.g., of [0058] comprising NaBhfip, and an electrolyte comprising NaBhfip(DME), synthesized with the conventional method. Multiple peaks are highlighted that are associated with 1,2-dimethoxyethane, which occur in the NaBhfip(DME) electrolyte and do not occur in the NaBhfip electrolyte. This serves to indicate the improved purity of the exemplary NaBhfip electrolyte described herein, synthesized according to the methods of this disclosure.

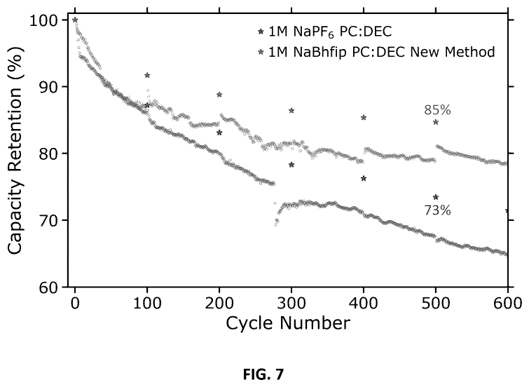

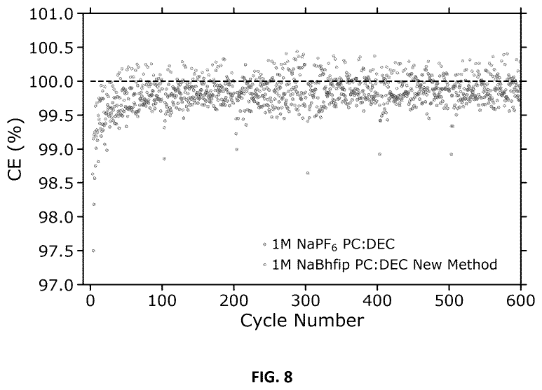

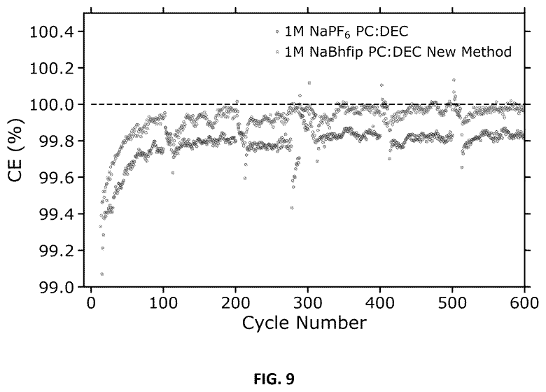

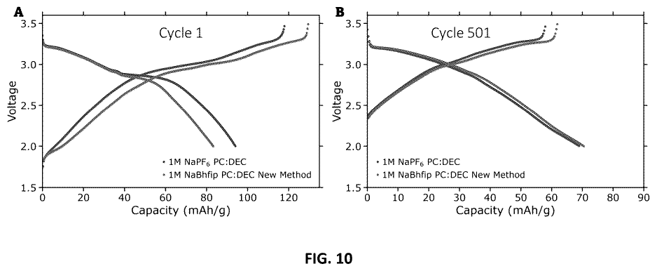

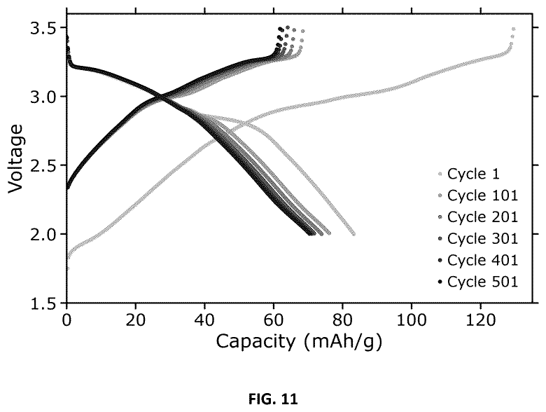

Exemplary, though non-limiting, data for sodium-based batteries in coin cell format are described in FIGS. 7-11. The data includes capacity retention, Coulombic efficiency, voltage profiles, and cycling performance comparisons between sodium borate ester electrolytes and a state-of-the-art conventional electrolyte comprising NaPF₆ in diglyme. These exemplary sodium-based batteries are fabricated by stacking an anode, separator, and cathode, and then wetting the separator and electrodes with electrolyte. The exemplary, though non-limiting, sodium borate electrolyte is described herein (e.g., as described in [0058]. A conventional lithium-based battery electrolyte would use a similar electrolyte chemistry, comprising LiPF₆ in carbonate solvents.

Described herein are electrolyte compositions having suitability for use in sodium-based batteries. In some embodiments, the electrolyte composition generally includes at least one sodium borate salt, at least one solvent, and a secondary sodium salt. In some embodiments, the secondary sodium salt is sodium difluoro(oxalato)borate (i.e., NaDFOB). In exemplary, though non-limiting, electrolyte compositions that comprise a secondary sodium salt (e.g., NaDFOB), the solvent may be any of those described herein (e.g., as described in [0047]), in addition to 1,2-dimethoxyethane. In exemplary, though non-limiting, electrolyte compositions that comprise a secondary sodium salt (e.g., NaDFOB), the at least one sodium borate ester salt has the formula NaB(OR)₄, wherein R is selected from an alkyl group, a fluoroalkyl group, a cyano-alkyl group, a functionalized alkyl group, a carboxyl group, a fluoro-carboxyl group, a functionalized carboxyl group, a phenyl group, a fluoro-phenyl group, a functionalized phenyl group, a sulfonyl group, a silyl group, and a nitrile group.

In some embodiments, the electrolyte as described herein (e.g., of [0070]) may further comprise one or more additional sodium salts. Exemplary, though non-limiting, supplemental salts are described herein (e.g., as described in [0051] and [0052]).

In some embodiments, the electrolyte as described herein (e.g., of [0070]) may further comprise at least one additive. Exemplary, though non-limiting, additives are described herein (e.g., in [0053]).

An exemplary, though non-limiting, electrolyte for sodium-based batteries has a composition that is comprised of sodium tetra(hexafluoro isopropoxy)borate, a solvent, and the sodium salt NaDFOB (i.e., sodium difluoro(oxalato)borate). Any suitable solvent may be used, providing that it does not prevent the electrolyte composition from functioning in a sodium-based battery. The salt, solvent, and additive may generally and approximately comprise 39, 60, and 1 wt % of the electrolyte, respectively.

In some embodiments, the solvent for the electrolyte described in [0073]9 may contain 1,2-dimethoxyethane (DME) in an amount that is greater than 8 wt %.

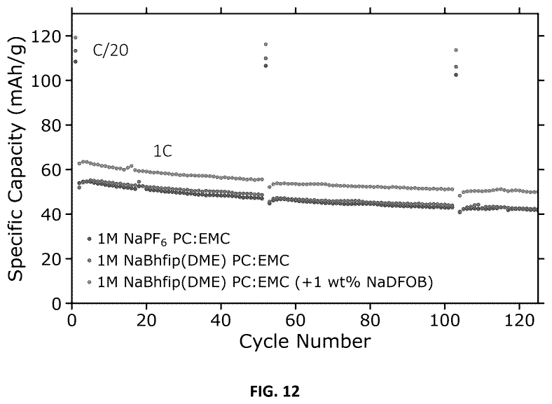

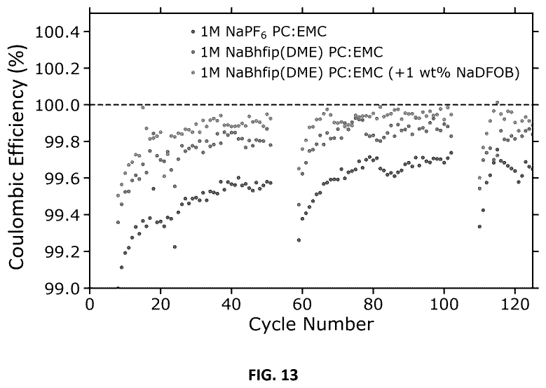

With respect to FIGS. 12 and 13, sodium-based battery performance data is described, including capacity retention, specific capacity, and Coulombic efficiency. In exemplary, though non-limiting, embodiments of the electrolyte comprising a sodium borate ester salt, a solvent, and sodium difluoro(oxalato)borate (i.e., NaDFOB), the performance of the electrolyte is superior to a conventional electrolyte for sodium-based batteries that comprises NaPF₆, and the inclusion of the salt NaDFOB provides superior performance relative to the electrolyte comprising a sodium borate ester and not comprising NaDFOB.

This data indicates that the sodium borate electrolytes and lithium borate electrolytes described herein can support highly reversible cycling for long cycle life, provide high Coulombic efficiency, and provide high specific capacity, all of which are optimal metrics for a sodium-based battery electrolyte and lithium-based battery electrolyte, respectively.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 2.5 to 10, 3.34 to 3.95, and so forth) or any values from 1 to 10 (e.g., 4, 6.8, 9.9993, and so forth).

### Additional Embodiments

Aspects of the present disclosure are described by the following numbered clauses.
1. An energy storage device comprising:
   an anode or anode-free substrate;
   a cathode; and
   an electrolyte coupling the anode or anode-free substrate to the cathode, wherein the electrolyte comprises:
      at least one sodium borate ester salt,
      dissolved in a liquid solvent that is substantially free of 1,2-dimethoxyethane (DME).
2. The energy storage device of clause 1, wherein the electrolyte comprises less than 1 equivalent of DME relative to at least one sodium borate ester salt.
3. The energy storage device of clause 1 or 2, wherein the liquid solvent comprises less than 8 wt % DME (e.g., less than 7 wt %, less than 6 wt %, less than 5 wt %, less than 4 wt %, less than 3 wt %, less than 2 wt %, or less than 1 wt % DME).
4. The energy storage device of any one of clauses 1-3, wherein the electrolyte comprises 0.5 M to 2M of the at least one sodium borate ester salt.
5. The energy storage device of any one of clauses 1-4, wherein the electrolyte is free of DME (i.e., undetectable).
6. The energy storage device of any one of clauses 1-5, wherein the at least one sodium borate ester salt is derived from an anhydrous salt form (i.e., not a solvate) dissolved in the liquid solvent.
7. The energy storage device of any one of clauses 1-6, wherein the at least one sodium borate ester salt has the formula:

NaB(OR)₄
wherein:
   each R or OR is independently selected from alkyl, substituted alkyl, carboxyl group, alkyl-C(═O)—, substituted alkyl-C(═O)—, phenyl, substituted phenyl, silyl group, sulfonyl group, and a nitrile group.
8. The energy storage device of clause 7, wherein each R or OR is independently selected from an alkyl group, a fluoroalkyl group, a cyano-alkyl group, a functionalized alkyl group, a carboxyl group, a fluoro-carboxyl group, a functionalized carboxyl group, a phenyl group, a fluoro-phenyl group, a functionalized phenyl group, a sulfonyl group, a silyl group, and a nitrile group.
9. The energy storage device of any one of clauses 1-8, wherein the at least one sodium borate ester salt is selected from sodium tetra(hexafluoro isopropoxy)borate, sodium tetra(1,1,1-trifluoro isopropoxy)borate, sodium tetra(2-trifluoromethyl isopropoxy)borate, sodium tetra(trifluoro ethoxy)borate, sodium tetra(difluoro ethoxy)borate, sodium bis(perfluoro pinacolato)borate, sodium tetra(pentafluoro phenoxy)borate, sodium tetra(perfluoro tertbutoxy)borate, sodium tetra(trifluoro acetoxy)borate, sodium tetra(3-methylphenoxy)borate, sodium tetra(4-methylphenoxy)borate, sodium tetra(2-fluoro-3-methylphenoxy)borate, sodium tetra(4-fluoro-3-methylphenoxy)borate, sodium tetra(2-fluoro-5-methylphenoxy)borate, sodium tetra(4-cyano phenoxy)borate, sodium tetra(3-cyano phenoxy)borate, sodium tetra(3,4-dicyano phenoxy)borate, sodium tetra(3,5-dicyano phenoxy)borate, sodium tetra(3-cyano-5-fluoro phenoxy)borate, sodium tetra(1-phenyl-2,2,2-trifluoro ethoxy)borate, sodium tetra(1-cyano-2,2,2-trifluoro ethoxy)borate, sodium tetra(1,1,1-trifluoro-2-cyano isopropoxy)borate, sodium tetra(2-cyano isopropoxy)borate, sodium tetra(1-cyano isopropoxy)borate, sodium tetra(2-cyano ethoxy)borate, sodium tetra(1-cyano-1-methoxy methoxy)borate, sodium tetra(1-cyano-1-ethoxy methoxy)borate, sodium tetra(1-cyano-1-phenyl methoxy)borate, sodium tetra(2-cyano-1-methoxy ethoxy)borate, sodium tetra(2-cyano-1-ethoxy ethoxy)borate, sodium tetra(methysulfonyl)borate, sodium tetra(trifluoromethysulfonyl)borate, sodium tetra(trimethylsiloxy)borate, and any combination thereof.
10. The energy storage device of any one of clauses 1-9, wherein the at least one sodium borate ester salt is sodium tetra(hexafluoro isopropoxy)borate.
11. The energy storage device of any one of clauses 1-10, wherein the liquid solvent is composed of one or more solvents that are non-aqueous.
12. The energy storage device of any one of clauses 1-11, wherein the liquid solvent comprises at least one solvent selected from an ester solvent, a carbonate solvent, a fluoro-ether solvent, a phosphate solvent, a phosphite solvent, a fluoro-ester solvent, an anhydride solvent, an amide solvent, a cyclic-ether solvent, a cyclic-ester solvent, a cyclic-sulfate solvent, a cyclic-carbonate solvent, a nitrile solvent, a cyclic-phosphate solvent, a sulfate solvent, a sulfone solvent, a sultone solvent, and combinations thereof.
13. The energy storage device of any one of clauses 1-12, wherein the liquid solvent comprises a carbonate solvent, a cyclic-carbonate solvent, or a combination thereof.
14. The energy storage device of clause 13, wherein the liquid solvent consists of a carbonate solvent, a cyclic-carbonate solvent, or a combination thereof.
15. The energy storage device of any one of clauses 1-14, wherein the liquid solvent comprises at least one solvent selected from dimethyl carbonate, diethyl carbonate, ethyl methyl carbonate, ethylene carbonate, propylene carbonate, diethylene glycol dimethyl ether (diglyme), triethylene glycol dimethyl ether (triglyme), tetraethylene glycol dimethyl ether (tetraglyme), triethyl phosphate, trimethyl phosphate, triethyl phosphite, trimethyl phosphite, fluoroethylene carbonate, ethyl butyrate, gamma-butyrolactone, gamma-valerolactone, triacetin, tetrahydrofuran, 1,3-dioxolane, acetic anhydride, N,N-dimethylformamide, dimethyl maleate, diethyl maleate, diallyl maleate, dimethyl malonate, diethyl malonate, dimethyl oxalate, diethyl oxalate, anisole, ethyl phenyl ether, methoxy perfluorobutane, methoxy perfluoropropane, ethoxy perfluorobutane, ethoxy perfluoropropane, diethyl ether, dipropyl ether, dibutyl ether, ethylene glycol diethyl ether, ethylene glycol dipropyl ether, ethylene glycol dibutyl ether, ethylal, triethyl orthoformate, sulfolane, 3-methyl sulfolane, 1,3-propane sultone, 1,4-butane sultone, 1,3,2-dioxathiolane 2,2-dioxide, 1,3,2-dioxathiane 2,2-dioxide, tetramethylene sulfoxide, 2,2-dimethoxy-propane, butyric anhydride, 1,1,2,2-tetrafluoroethyl-2,2,3,3-tetrafluoropropyl ether, 1,1,2,2-tetrafluoroethyl 2,2,2-trifluoroethyl ether, methyl (2,2,2-trifluoroethyl) carbonate, hexafluoroisopropyl methyl ether, hexafluoroisopropyl ethyl ether, hexafluoroisopropyl propyl ether, hexafluoroisopropyl butyl ether, tris(2,2,2-trifluoroethyl) phosphite, methyl trifluoroacetate, ethyl trifluoroacetate, propyl trifluoroacetate, isopropyl trifluoroacetate, butyl trifluoroacetate, methyl cyanoformate, ethyl cyanoformate, and any combination thereof.
16. The energy storage device of any one of clauses 1-15, wherein the electrolyte further comprises at least one supplemental sodium salt, or a combination of two or more supplemental sodium salts.
17. The energy storage device of clause 16, wherein the at least one supplemental salt is selected from sodium hexafluorophosphate, sodium tetrafluoroborate, sodium perchlorate, sodium bis(oxalato)borate, sodium difluoro(oxalato)borate, sodium (trifluoromethane sulfonyl)imide, sodium bis(fluoro sulfonyl)imide, sodium trifluoroacetate, sodium heptafluorobutyrate, sodium pentafluoropropionate, sodium trifluoromethanesulfonate, sodium fluorosulfate, sodium nitrate, sodium difluoro(bisoxalato)phosphate, sodium difluorophosphate, sodium methanesulfonate, sodium sulfamate, sodium naphthalene-2-sulfonate, sodium bis(trimethylsilyl)amide, sodium trimethylsilanolate, sodium bis(malato)borate, and sodium difluoro(malato)borate.
18. The energy storage device of any one of clauses 1-17, wherein the electrolyte further comprises at least one additive, or a combination of two or more additives.
19. The energy storage device of clause 18, wherein the at least one additive is selected from vinyl carbonate, vinylene carbonate, fluoroethylene carbonate, 1,3-propane sultone, 1,4-butane sultone, 1,3,2-dioxathiolane 2,2-dioxide, thiophene, sodium difluoro(bisoxalato) phosphate, sodium difluorophosphate, sodium bis(oxalato)borate, sodium difluoro(oxalato)borate, trimethyl phosphite, tris(trimethylsilyl)phosphite, trimethyl borate, sodium tetra(methyl)borate, triethyl borate, tris(trimethylsilyl)borate, biphenyl, boron trifluoride, maleic anhydride, succinic anhydride, itaconic anhydride, trifluoroacetic anhydride, trifluoromethanesulfonic anhydride, trimethylboroxine, trihydroxybenzene, succinimide, lithium nitrate, diethyl pyrocarbonate, vinyl acetate, trimethyl(trifluoromethyl)silane, aluminum ethoxide, titanium isopropoxide, lithium difluoro(bisoxalato)phosphate, lithium difluorophosphate, lithium bis(oxalato)borate, lithium difluoro(oxalato)borate.
20. The energy storage device of any one of clauses 1-19, wherein the anode or anode-free substrate is selected from hard carbon, sodium metal, aluminum foil, graphite, other carbon-based materials, tin, lead, or a combination thereof.
21. The energy storage device of any one of clauses 1-20, wherein the cathode is composed of a material selected from:
   sodium nickel-iron-manganese oxide (NFM, e.g., NaNiₓFe_{y}Mn_{z}O₂, where x+y+z=1),
   sodium transition metal oxide (e.g., NaₓTMO₂ wherein TM =a transition metal, Fe, Mn, Ni, Co, Cr, Ti, V, or combination thereof; x>0 and ≤1),
   NaₐNi_{1-x-y-z}MnₓMg_{y}Ti_{z}O₂ (a>0 and ≤1; x+y+z=1),
   sodium copper-iron-manganese oxide (NaₐCuₓFe_{y}Mn_{z}O₂, where a>0 and ≤1; x+y+z=1),
   sodium ferric phosphate pyrophosphate (NFPP, Na₄Fe₃(PO₄)₂(P₂O₇)),
   Na₃V₂PO₄,
   sodium chromium oxide (NaCrO₂),
   potassium-doped sodium manganese oxide (NaₐK_{b}MnO₂, where a+b≤1),
   Prussian White (NaₐFeMn(CN)₆, where a>0 and ≤2),
   Prussian Blue (NaₐFe₂(CN)₆, where a>0 and ≤2),
   a metal phosphate, pyrophosphate, or diphosphate (e.g., including Fe, Mn, V, Ti, or a combination thereof),
   a metal sulfide (e.g., sodium sulfide), or
   a combination thereof.
22. A method of making an electrolyte composition comprising: combining:
   sodium borohydride;
   a solvent or blend of solvents substantially free of DME; and
   an acidic precursor,
under conditions sufficient to form an electrolyte solution comprising a sodium borate ester salt, and a solvent or blend of solvents substantially free of DME.
23. The method of clause 22, wherein the solvent or blend of solvents does not comprise DME.
24. The method of any one of clauses 22-23, wherein the liquid solvent comprises at least one solvent selected from an ester solvent, a carbonate solvent, a fluoro-ether solvent, a phosphate solvent, a phosphite solvent, a fluoro-ester solvent, an anhydride solvent, an amide solvent, a cyclic-ether solvent, a cyclic-ester solvent, a cyclic-sulfate solvent, a cyclic-carbonate solvent, a nitrile solvent, a cyclic-phosphate solvent, a sulfate solvent, a sulfone solvent, a sultone solvent, and combinations thereof.
25. The method of any one of clauses 22-24, wherein the liquid solvent is a carbonate solvent, a cyclic-carbonate solvent, or a combination thereof.
26. The method of any one of clauses 22-25, wherein the acidic precursor has the formula ROH, where R is selected from an alkyl group, a fluoroalkyl group, a cyano-alkyl group, a functionalized alkyl group, a carboxyl group, a fluoro-carboxyl group, a functionalized carboxyl group, a phenyl group, a fluoro-phenyl group, a functionalized phenyl group, a sulfonyl group, a silyl group, and a nitrile group.
27. The method of clauses 22-26, wherein the combining occurs in a batch reactor.
28. The method of clause 22-26, wherein the combining occurs in a continuous stirred tank reactor.
29. The method of clauses 22-28, wherein the combining to form the electrolyte solution is performed in a reactor that is maintained at a temperature between −20 °C to 150 °C
30. The method of clauses 22-29, wherein the reaction reaches a conversion of sodium borohydride to sodium borate ester salt of >50%.
31. The method of clause 30, wherein the reaction reaches a conversion of sodium borohydride to sodium borate ester salt of >90%.
32. An energy storage device comprising:
   an anode or anode-free substrate;
   a cathode; and
   an electrolyte coupling the anode or anode-free substrate to the cathode, wherein the electrolyte comprises:
      at least one lithium borate ester salt,
      dissolved in a liquid solvent that is substantially free of DME.
33. The energy storage device of clause 32, wherein the electrolyte comprises less than 1 equivalent of DME relative to at least one lithium borate ester salt.
34. The energy storage device of clause 32 or 33, wherein the liquid solvent comprises less than 8 wt % DME (e.g., less than 7 wt %, less than 6 wt %, less than 5 wt %, less than 4 wt %, less than 3 wt %, less than 2 wt %, or less than 1 wt % DME).
35. The energy storage device of any one of clauses 32-34, wherein the electrolyte comprises 0.5 M to 2M of the at least one lithium borate ester salt.
36. The energy storage device of any one of clauses 32-35, wherein the electrolyte is free of DME (i.e., undetectable).
37. The energy storage device of any one of clauses 32-36, wherein the at least one lithium borate ester salt is derived from an anhydrous salt form (i.e., not a solvate) dissolved in the liquid solvent.
38. The energy storage device of any one of clauses 32-37, wherein the at least one lithium borate ester salt has the formula:

LiB(OR)₄,
wherein:
   each R or OR is independently selected from alkyl, substituted alkyl, carboxyl group, alkyl-C(═O)—, substituted alkyl-C(═O)—, phenyl, substituted phenyl, silyl group, sulfonyl group, and a nitrile group.
39. The energy storage device of clause 38, wherein each R or OR is independently selected from an alkyl group, a fluoroalkyl group, a cyano-alkyl group, a functionalized alkyl group, a carboxyl group, a fluoro-carboxyl group, a functionalized carboxyl group, a phenyl group, a fluoro-phenyl group, a functionalized phenyl group, a sulfonyl group, a silyl group, and a nitrile group.
40. The energy storage device of any one of clauses 32-39, wherein the at least one lithium borate ester salt is selected from lithium tetra(hexafluoro isopropoxy)borate, lithium tetra(1,1,1-trifluoro isopropoxy)borate, lithium tetra(2-trifluoromethyl isopropoxy)borate, lithium tetra(trifluoro ethoxy)borate, lithium tetra(difluoro ethoxy)borate, lithium bis(perfluoro pinacolato)borate, lithium tetra(pentafluoro phenoxy)borate, lithium tetra(perfluoro tertbutoxy)borate, lithium tetra(trifluoro acetoxy)borate, lithium tetra(3-methylphenoxy)borate, lithium tetra(4-methylphenoxy)borate, lithium tetra(2-fluoro-3-methylphenoxy)borate, lithium tetra(4-fluoro-3-methylphenoxy)borate, lithium tetra(2-fluoro-5-methylphenoxy)borate, lithium tetra(4-cyano phenoxy)borate, lithium tetra(3-cyano phenoxy)borate, lithium tetra(3,4-dicyano phenoxy)borate, lithium tetra(3,5-dicyano phenoxy)borate, lithium tetra(3-cyano-5-fluoro phenoxy)borate, lithium tetra(1-phenyl-2,2,2-trifluoro ethoxy)borate, lithium tetra(1-cyano-2,2,2-trifluoro ethoxy)borate, lithium tetra(1,1,1-trifluoro-2-cyano isopropoxy)borate, lithium tetra(2-cyano isopropoxy)borate, lithium tetra(1-cyano isopropoxy)borate, lithium tetra(2-cyano ethoxy)borate, lithium tetra(1-cyano-1-methoxy methoxy)borate, lithium tetra(1-cyano-1-ethoxy methoxy)borate, lithium tetra(1-cyano-1-phenyl methoxy)borate, lithium tetra(2-cyano-1-methoxy ethoxy)borate, lithium tetra(2-cyano-1-ethoxy ethoxy)borate, lithium tetra(methysulfonyl)borate, lithium tetra(trifluoromethysulfonyl)borate, lithium tetra(trimethylsiloxy)borate, or any combination thereof.
41. The energy storage device of any one of clauses 32-40, wherein the at least one lithium borate ester salt is lithium tetra(hexafluoro isopropoxy)borate.
42. The energy storage device of clauses 32-41, wherein the liquid solvent comprises at least one solvent selected from an ester solvent, a carbonate solvent, a fluoro-ether solvent, a phosphate solvent, a phosphite solvent, a fluoro-ester solvent, an anhydride solvent, an amide solvent, a cyclic-ether solvent, a cyclic-ester solvent, a cyclic-sulfate solvent, a cyclic-carbonate solvent, a nitrile solvent, a cyclic-phosphate solvent, a sulfate solvent, a sulfone solvent, and a sultone solvent.
43. The energy storage device of any one of clauses 32-42, wherein the liquid solvent comprises a carbonate solvent, a cyclic-carbonate solvent, or a combination thereof.
44. The energy storage device of clause 43, wherein the liquid solvent consists of a carbonate solvent, a cyclic-carbonate solvent, or a combination thereof.
45. The energy storage device of clauses 32-44, wherein the at least one solvent is selected from dimethyl carbonate, diethyl carbonate, ethyl methyl carbonate, ethylene carbonate, propylene carbonate, diethylene glycol dimethyl ether (diglyme), triethylene glycol dimethyl ether (triglyme), tetraethylene glycol dimethyl ether (tetraglyme), triethyl phosphate, trimethyl phosphate, triethyl phosphite, trimethyl phosphite, fluoroethylene carbonate, ethyl butyrate, gamma-butyrolactone, gamma-valerolactone, triacetin, tetrahydrofuran, 1,3-dioxolane, acetic anhydride, N,N-dimethylformamide, dimethyl maleate, diethyl maleate, diallyl maleate, dimethyl malonate, diethyl malonate, dimethyl oxalate, diethyl oxalate, anisole, ethyl phenyl ether, methoxy perfluorobutane, methoxy perfluoropropane, ethoxy perfluorobutane, ethoxy perfluoropropane, diethyl ether, dipropyl ether, dibutyl ether, ethylene glycol diethyl ether, ethylene glycol dipropyl ether, ethylene glycol dibutyl ether, ethylal, triethyl orthoformate, sulfolane, 3-methyl sulfolane, 1,3-propane sultone, 1,4-butane sultone, 1,3,2-dioxathiolane 2,2-dioxide, 1,3,2-dioxathiane 2,2-dioxide, tetramethylene sulfoxide, 2,2-dimethoxy-propane, butyric anhydride, 1,1,2,2-tetrafluoroethyl-2,2,3,3-tetrafluoropropyl ether, 1,1,2,2-tetrafluoroethyl 2,2,2-trifluoroethyl ether, methyl (2,2,2-trifluoroethyl) carbonate, hexafluoroisopropyl methyl ether, hexafluoroisopropyl ethyl ether, hexafluoroisopropyl propyl ether, hexafluoroisopropyl butyl ether, tris(2,2,2-trifluoroethyl) phosphite, methyl trifluoroacetate, ethyl trifluoroacetate, propyl trifluoroacetate, isopropyl trifluoroacetate, butyl trifluoroacetate, methyl cyanoformate, ethyl cyanoformate, or any combination thereof.
46. The energy storage device of clauses 32-45, wherein the electrolyte further comprises at least one supplemental lithium salt, or a combination of two or more supplemental lithium salts.
47. The energy storage device of clause 46, wherein the at least one supplemental lithium salt is selected from lithium hexafluorophosphate, lithium tetrafluoroborate, lithium perchlorate, lithium bis(oxalato)borate, lithium difluoro(oxalato)borate, lithium (trifluoromethane sulfonyl)imide, lithium bis(fluoro sulfonyl)imide, lithium trifluoroacetate, lithium heptafluorobutyrate, lithium pentafluoropropionate, lithium trifluoromethanesulfonate, lithium fluorosulfate, lithium nitrate, lithium difluoro(bisoxalato)phosphate, lithium difluorophosphate, lithium methanesulfonate, lithium sulfamate, lithium naphthalene-2-sulfonate, lithium bis(trimethylsilyl)amide, lithium trimethylsilanolate, lithium bis(malato)borate, and lithium difluoro(malato)borate.
48. The energy storage device of clauses 32-47, wherein the electrolyte further comprises at least one additive, or a combination of two or more additives.
49. The energy storage device of clause 48, wherein the at least one additive is selected from vinyl carbonate, vinylene carbonate, fluoroethylene carbonate, 1,3-propane sultone, 1,4-butane sultone, 1,3,2-dioxathiolane 2,2-dioxide, thiophene, lithium difluoro(bisoxalato)phosphate, lithium difluorophosphate, lithium bis(oxalato)borate, lithium difluoro(oxalato)borate, trimethyl phosphite, tris(trimethylsilyl)phosphite, trimethyl borate, lithium tetra(methyl)borate, triethyl borate, tris(trimethylsilyl)borate, biphenyl, boron trifluoride, maleic anhydride, succinic anhydride, itaconic anhydride, trifluoroacetic anhydride, trifluoromethanesulfonic anhydride, trimethylboroxine, trihydroxybenzene, succinimide, lithium nitrate, diethyl pyrocarbonate, vinyl acetate, trimethyl(trifluoromethyl)silane, aluminum ethoxide, titanium isopropoxide.
50. The energy storage device of clauses 32-49, wherein the anode is selected from graphite, lithium metal, aluminum foil, copper foil, silicon, other carbon-based materials, or a combination thereof.
51. The energy storage device of clauses 32-50, wherein the cathode is selected from a metal oxide having the general formula LiₓMO₂, where x is >0 and ≤1, containing, but not limited to, Ni, Fe, Mn, Co, Al, or a combination thereof, a metal phosphate, pyrophosphate, or diphosphate containing, but not limited to, Fe, Mn, V, Ti, or a combination thereof, a metal sulfide, lithium sulfide, lithium nickel-manganese-cobalt oxide (NMC, LiNiₓMn_{y}Co_{z}O₂, where x+y+z=1), lithium nickel-cobalt-aluminum oxide (NCA, LiNiₓCo_{y}Al_{z}O₂, where x+y+z=1), lithium iron phosphate (LFP, LiFePO₄), and lithium iron manganese phosphate (LMFP, LiMnₓFe_{y}PO₄, where x+y=1).
52. A method of making an electrolyte composition comprising:
   combining:
      lithium borohydride;
      a solvent or blend of solvents substantially free of DME; and
      an acidic precursor,
   under conditions sufficient to form an electrolyte solution comprising a lithium borate ester salt, and a solvent or blend of solvents substantially free of DME.
53. The method of clause 52, wherein the solvent or blend of solvents does not comprise DME.
54. The method of any one of clauses 52-53, wherein the liquid solvent comprises at least one solvent selected from an ester solvent, a carbonate solvent, a fluoro-ether solvent, a phosphate solvent, a phosphite solvent, a fluoro-ester solvent, an anhydride solvent, an amide solvent, a cyclic-ether solvent, a cyclic-ester solvent, a cyclic-sulfate solvent, a cyclic-carbonate solvent, a nitrile solvent, a cyclic-phosphate solvent, a sulfate solvent, a sulfone solvent, a sultone solvent, and combinations thereof.
55. The method of any one of clauses 52-54, wherein the liquid solvent is a carbonate solvent, a cyclic-carbonate solvent, or a combination thereof.
56. The method of any one of clauses 52-55, wherein the acidic precursor has the formula ROH, where R is selected from an alkyl group, a fluoroalkyl group, a cyano-alkyl group, a functionalized alkyl group, a carboxyl group, a fluoro-carboxyl group, a functionalized carboxyl group, a phenyl group, a fluoro-phenyl group, a functionalized phenyl group, a sulfonyl group, a silyl group, and a nitrile group.
57. The method of clauses 52-56, wherein the combining occurs in a batch reactor.
58. The method of clause 52-56, wherein the combining occurs in a continuous stirred tank reactor.
59. The method of clauses 52-58, wherein the combining to form the electrolyte solution is performed in a reactor that is maintained at a temperature between −20 °C to 150 °C
60. The method of clauses 52-59, wherein the reaction reaches a conversion of lithium borohydride to lithium borate ester salt of >50%.
61. The method of clause 60, wherein the reaction reaches a conversion of lithium borohydride to lithium borate ester salt of >90%.
62. An energy storage device comprising:
   an anode or anode-free substrate;
   a cathode; and
   an electrolyte coupling the anode to the cathode or anode-free substrate, wherein
      the electrolyte comprises:
         at least one sodium borate ester salt; and
         sodium difluoro(oxalato)borate; and
         at least one solvent.
63. The energy storage device of clause 62, wherein the at least one sodium borate ester salt has the formula NaB(OR)₄, wherein R is selected from an alkyl group, a fluoroalkyl group, a cyano-alkyl group, a functionalized alkyl group, a carboxyl group, a fluoro-carboxyl group, a functionalized carboxyl group, a phenyl group, a fluoro-phenyl group, a functionalized phenyl group, a sulfonyl group, a silyl group, and a nitrile group.
64. The energy storage device of clauses 62-63, wherein the at least one sodium borate ester salt is selected from sodium tetra(hexafluoro isopropoxy)borate, sodium tetra(1,1,1-trifluoro isopropoxy)borate, sodium tetra(2-trifluoromethyl isopropoxy)borate, sodium tetra(trifluoro ethoxy)borate, sodium tetra(difluoro ethoxy)borate, sodium bis(perfluoro pinacolato)borate, sodium tetra(pentafluoro phenoxy)borate, sodium tetra(perfluoro tertbutoxy)borate, sodium tetra(trifluoro acetoxy)borate, sodium tetra(3-methylphenoxy)borate, sodium tetra(4-methylphenoxy)borate, sodium tetra(2-fluoro-3-methylphenoxy)borate, sodium tetra(4-fluoro-3-methylphenoxy)borate, sodium tetra(2-fluoro-5-methylphenoxy)borate, sodium tetra(4-cyano phenoxy)borate, sodium tetra(3-cyano phenoxy)borate, sodium tetra(3,4-dicyano phenoxy)borate, sodium tetra(3,5-dicyano phenoxy)borate, sodium tetra(3-cyano-5-fluoro phenoxy)borate, sodium tetra(1-phenyl-2,2,2-trifluoro ethoxy)borate, sodium tetra(1-cyano-2,2,2-trifluoro ethoxy)borate, sodium tetra(1,1,1-trifluoro-2-cyano isopropoxy)borate, sodium tetra(2-cyano isopropoxy)borate, sodium tetra(1-cyano isopropoxy)borate, sodium tetra(2-cyano ethoxy)borate, sodium tetra(1-cyano-1-methoxy methoxy)borate, sodium tetra(1-cyano-1-ethoxy methoxy)borate, sodium tetra(1-cyano-1-phenyl methoxy)borate, sodium tetra(2-cyano-1-methoxy ethoxy)borate, sodium tetra(2-cyano-1-ethoxy ethoxy)borate, sodium tetra(methysulfonyl)borate, sodium tetra(trifluoromethysulfonyl)borate, sodium tetra(trimethylsilyl)borate.
65. The energy storage device of clauses 62-64, wherein the at least one solvent is selected from an ester solvent, a carbonate solvent, a fluoro-ether solvent, a phosphate solvent, a phosphite solvent, a fluoro-ester solvent, an anhydride solvent, an amide solvent, a cyclic-ether solvent, a cyclic-ester solvent, a cyclic-sulfate solvent, a cyclic-carbonate solvent, a nitrile solvent, a cyclic-phosphate solvent, a sulfate solvent, a sulfone solvent, and a sultone solvent.
66. The energy storage device of clauses 62-65, wherein the at least one solvent is selected from dimethyl carbonate, diethyl carbonate, ethyl methyl carbonate, ethylene carbonate, propylene carbonate, diethylene glycol dimethyl ether (diglyme), triethylene glycol dimethyl ether (triglyme), tetraethylene glycol dimethyl ether (tetraglyme), triethyl phosphate, trimethyl phosphate, triethyl phosphite, trimethyl phosphite, fluoroethylene carbonate, ethyl butyrate, gamma-butyrolactone, gamma-valerolactone, triacetin, tetrahydrofuran, 1,3-dioxolane, acetic anhydride, N,N-dimethylformamide, dimethyl maleate, diethyl maleate, diallyl maleate, dimethyl malonate, diethyl malonate, dimethyl oxalate, diethyl oxalate, anisole, ethyl phenyl ether, methoxy perfluorobutane, methoxy perfluoropropane, ethoxy perfluorobutane, ethoxy perfluoropropane, diethyl ether, dipropyl ether, dibutyl ether, ethylene glycol diethyl ether, ethylene glycol dipropyl ether, ethylene glycol dibutyl ether, ethylal, triethyl orthoformate, sulfolane, 3-methyl sulfolane, 1,3-propane sultone, 1,4-butane sultone, 1,3,2-dioxathiolane 2,2-dioxide, 1,3,2-dioxathiane 2,2-dioxide, tetramethylene sulfoxide, 2,2-dimethoxy-propane, butyric anhydride, 1,1,2,2-tetrafluoroethyl-2,2,3,3-tetrafluoropropyl ether, 1,1,2,2-tetrafluoroethyl 2,2,2-trifluoroethyl ether, methyl (2,2,2-trifluoroethyl) carbonate, hexafluoroisopropyl methyl ether, hexafluoroisopropyl ethyl ether, hexafluoroisopropyl propyl ether, hexafluoroisopropyl butyl ether, tris(2,2,2-trifluoroethyl) phosphite, methyl trifluoroacetate, ethyl trifluoroacetate, propyl trifluoroacetate, isopropyl trifluoroacetate, butyl trifluoroacetate, methyl cyanoformate, ethyl cyanoformate, or any combination thereof.
67. The electrolyte composition of clauses 62-66, further comprising at least one supplemental sodium salt, or a combination of two or more supplemental sodium salts.
68. The electrolyte of clause 67, wherein the at least one supplemental salt is selected from sodium hexafluorophosphate, sodium tetrafluoroborate, sodium perchlorate, sodium bis(oxalato)borate, sodium difluoro(oxalato)borate, sodium (trifluoromethane sulfonyl)imide, sodium bis(fluoro sulfonyl)imide, sodium trifluoroacetate, sodium heptafluorobutyrate, sodium pentafluoropropionate, sodium trifluoromethanesulfonate, sodium fluorosulfate, sodium nitrate, sodium difluoro(bisoxalato)phosphate, sodium difluorophosphate, sodium methanesulfonate, sodium sulfamate, sodium naphthalene-2-sulfonate, sodium bis(trimethylsilyl)amide, sodium trimethylsilanolate, sodium bis(malato)borate, sodium difluoro(malato)borate.
69. The electrolyte of clauses 62-68, further comprising at least one additive, or a combination of two or more additives.
70. The electrolyte of clause 69, wherein the at least one additive is selected from vinyl carbonate, vinylene carbonate, fluoroethylene carbonate, 1,3-propane sultone, 1,4-butane sultone, 1,3,2-dioxathiolane 2,2-dioxide, thiophene, sodium difluoro(bisoxalato) phosphate, sodium difluorophosphate, sodium bis(oxalato)borate, sodium difluoro(oxalato)borate, trimethyl phosphite, tris(trimethylsilyl)phosphite, trimethyl borate, sodium tetra(methyl)borate, triethyl borate, tris(trimethylsilyl)borate, biphenyl, boron trifluoride, maleic anhydride, succinic anhydride, itaconic anhydride, trifluoroacetic anhydride, trifluoromethanesulfonic anhydride, trimethylboroxine, trihydroxybenzene, succinimide, lithium nitrate, diethyl pyrocarbonate, vinyl acetate, trimethyl(trifluoromethyl)silane, aluminum ethoxide, titanium isopropoxide, lithium difluoro(bisoxalato)phosphate, lithium difluorophosphate, lithium bis(oxalato)borate, lithium difluoro(oxalato)borate.
71. The energy storage device of clauses 62-70, wherein the anode is selected from hard carbon, sodium metal, aluminum foil, graphite, other carbon-based materials, tin, lead, or a combination thereof.
72. The energy storage device of clause 62-71, wherein the cathode is selected from sodium nickel-iron-manganese oxide (NFM, NaNiₓFe_{y}Mn_{z}O₂, where x+y+z=1), sodium transition metal oxides including NaₓTMO₂ (TM=a transition metal, Fe, Mn, Ni, Co, Cr, Ti, V, or combination thereof; x>0 and ≤1), NaₐNi_{1-x-y-z}MnₓMg_{y}Ti_{z}O₂ (a>0 and ≤1; x+y+z=1), sodium copper-iron-manganese oxide (NaₐCuₓFe_{y}Mn_{z}O₂, where a>0 and ≤1; x+y+z=1), sodium ferric phosphate pyrophosphate (NFPP, Na₄Fe₃(PO₄)₂(P₂O₇)), Na₃V₂PO₄, sodium chromium oxide (NaCrO₂), potassium-doped sodium manganese oxide (NaₐK_{b}MnO₂, where a+b≤1), Prussian White (NaₐFeMn(CN)₆, where a>0 and ≤2), Prussian Blue (NaₐFe₂(CN)₆, where a>0 and ≤2), a metal phosphate, pyrophosphate, or diphosphate containing, but not limited to, Fe, Mn, V, Ti, or a combination thereof, a metal sulfide, sodium sulfide, and a combination thereof.

### EQUIVALENTS AND INCORPORATION BY REFERENCE

While the invention has been particularly shown and described with reference to a preferred embodiment and various alternate embodiments, it will be understood by persons skilled in the relevant art that various changes in form and details can be made therein without departing from the spirit and scope of the invention.

All references, issued patents and patent applications cited within the body of the instant specification, and U.S. application No. 63/706,529, filed Oct. 11, 2024, are hereby incorporated by reference in their entirety, for all purposes.

1. An energy storage device comprising:
at least one negative electrode; and
at least one positive electrode; and
an electrolyte coupling the at least one negative electrode to the at least one positive electrode, wherein the electrolyte comprises:
at least one sodium borate ester salt; and
a liquid solvent that comprises less than 8 wt % of 1,2-dimethoxyethane (DME).

2. The energy storage device of claim 1, wherein the liquid solvent comprises less than 5 wt % DME.

3. The energy storage device of claim 1, wherein DME is undetectable in the electrolyte.

4. (canceled)

5. The energy storage device of claim 1 wherein the liquid solvent comprises more than 92 wt % of at least one solvent selected from an ester solvent, a carbonate solvent, a fluoro-ether solvent, a phosphate solvent, a phosphite solvent, a fluoro-ester solvent, an anhydride solvent, an amide solvent, a cyclic-ether solvent, a cyclic-ester solvent, a cyclic-sulfate solvent, a cyclic-carbonate solvent, a nitrile solvent, a cyclic-phosphate solvent, a sulfate solvent, a sulfone solvent, a sultone solvent, dimethyl carbonate, diethyl carbonate, ethyl methyl carbonate, ethylene carbonate, propylene carbonate, diethylene glycol dimethyl ether (diglyme), triethylene glycol dimethyl ether (triglyme), tetraethylene glycol dimethyl ether (tetraglyme), triethyl phosphate, trimethyl phosphate, triethyl phosphite, trimethyl phosphite, fluoroethylene carbonate, ethyl butyrate, gamma-butyrolactone, gamma-valerolactone, triacetin, tetrahydrofuran, 1,3-dioxolane, acetic anhydride, N,N-dimethylformamide, dimethyl maleate, diethyl maleate, diallyl maleate, dimethyl malonate, diethyl malonate, dimethyl oxalate, diethyl oxalate, anisole, ethyl phenyl ether, methoxy perfluorobutane, methoxy perfluoropropane, ethoxy perfluorobutane, ethoxy perfluoropropane, diethyl ether, dipropyl ether, dibutyl ether, ethylene glycol diethyl ether, ethylene glycol dipropyl ether, ethylene glycol dibutyl ether, ethylal, triethyl orthoformate, sulfolane, 3-methyl sulfolane, 1,3-propane sultone, 1,4-butane sultone, 1,3,2-dioxathiolane 2,2-dioxide, 1,3,2-dioxathiane 2,2-dioxide, tetramethylene sulfoxide, 2,2-dimethoxy-propane, butyric anhydride, 1,1,2,2-tetrafluoroethyl-2,2,3,3-tetrafluoropropyl ether, 1,1,2,2-tetrafluoroethyl 2,2,2-trifluoroethyl ether, methyl (2,2,2-trifluoroethyl) carbonate, hexafluoroisopropyl methyl ether, hexafluoroisopropyl ethyl ether, hexafluoroisopropyl propyl ether, hexafluoroisopropyl butyl ether, tris(2,2,2-trifluoroethyl) phosphite, methyl trifluoroacetate, ethyl trifluoroacetate, propyl trifluoroacetate, isopropyl trifluoroacetate, butyl trifluoroacetate, methyl cyanoformate, ethyl cyanoformate, and combinations thereof.

6. The energy storage device of claim 1, wherein the at least one sodium borate ester salt comprises a sodium borate ester salt of formula:
NaB(OR)₄
wherein:
each R is independently selected from alkyl, a fluoroalkyl group, a cyano-alkyl group, a functionalized alkyl group, a carboxyl group, a fluoro-carboxyl group, a functionalized carboxyl group, a phenyl group, a fluoro-phenyl group, a functionalized phenyl group, a sulfonyl group, a silyl group, and a nitrile group.

7. (canceled)

8. The energy storage device of claim 1, wherein the at least one sodium borate ester salt that is selected from sodium tetra(hexafluoro isopropoxy)borate, sodium tetra(1,1,1-trifluoro isopropoxy)borate, sodium tetra(2-trifluoromethyl isopropoxy)borate, sodium tetra(trifluoro ethoxy)borate, sodium tetra(difluoro ethoxy)borate, sodium bis(perfluoro pinacolato)borate, sodium tetra(pentafluoro phenoxy)borate, sodium tetra(perfluoro tertbutoxy)borate, sodium tetra(trifluoro acetoxy)borate, sodium tetra(3-methylphenoxy)borate, sodium tetra(4-methylphenoxy)borate, sodium tetra(2-fluoro-3-methylphenoxy)borate, sodium tetra(4-fluoro-3-methylphenoxy)borate, sodium tetra(2-fluoro-5-methylphenoxy)borate, sodium tetra(4-cyano phenoxy)borate, sodium tetra(3-cyano phenoxy)borate, sodium tetra(3,4-dicyano phenoxy)borate, sodium tetra(3,5-dicyano phenoxy)borate, sodium tetra(3-cyano-5-fluoro phenoxy)borate, sodium tetra(1-phenyl-2,2,2-trifluoro ethoxy)borate, sodium tetra(1-cyano-2,2,2-trifluoro ethoxy)borate, sodium tetra(1,1,1-trifluoro-2-cyano isopropoxy)borate, sodium tetra(2-cyano isopropoxy)borate, sodium tetra(1-cyano isopropoxy)borate, sodium tetra(2-cyano ethoxy)borate, sodium tetra(1-cyano-1-methoxy methoxy)borate, sodium tetra(1-cyano-1-ethoxy methoxy)borate, sodium tetra(1-cyano-1-phenyl methoxy)borate, sodium tetra(2-cyano-1-methoxy ethoxy)borate, sodium tetra(2-cyano-1-ethoxy ethoxy)borate, sodium tetra(methysulfonyl)borate, sodium tetra(trifluoromethysulfonyl)borate, sodium tetra(trimethylsiloxy)borate, and any combination thereof.

9. (canceled)

10. The energy storage device of claim 1, wherein the at least one borate ester salt is selected from sodium tetra(hexafluoro isopropoxy)borate, sodium tetra(1,1,1-trifluoro isopropoxy)borate, and sodium tetra(trifluoro ethoxy)borate.

11. (canceled)

12. (canceled)

13. The energy storage device of claim 1, wherein the electrolyte further comprises at least one additive, or a combination of two or more additives.

14. The energy storage device of claim 13, wherein the at least one additive is selected from vinyl carbonate, vinylene carbonate, fluoroethylene carbonate, 1,3-propane sultone, 1,4-butane sultone, 1,3,2-dioxathiolane 2,2-dioxide, thiophene, sodium difluoro(bisoxalato) phosphate, sodium difluorophosphate, sodium bis(oxalato)borate, sodium difluoro(oxalato)borate, trimethyl phosphite, tris(trimethylsilyl)phosphite, trimethyl borate, sodium tetra(methyl)borate, triethyl borate, tris(trimethylsilyl)borate, biphenyl, boron trifluoride, maleic anhydride, succinic anhydride, itaconic anhydride, trifluoroacetic anhydride, trifluoromethanesulfonic anhydride, trimethylboroxine, trihydroxybenzene, succinimide, lithium nitrate, diethyl pyrocarbonate, vinyl acetate, trimethyl(trifluoromethyl)silane, aluminum ethoxide, titanium isopropoxide, lithium difluoro(bisoxalato)phosphate, lithium difluorophosphate, lithium bis(oxalato)borate, and lithium difluoro(oxalato)borate.

15. A method of making an electrolyte composition comprising:
combining:
sodium borohydride; and
a solvent or blend of solvents that comprises less than 8 wt % of DME; and
an acidic precursor,
under conditions sufficient to form an electrolyte solution comprising a borate ester salt in the solvent or blend of solvents.

16. The method of claim 15, wherein the solvent or blend of solvents comprises less than 5 wt % DME.

17. The method of claim 15, wherein DME is undetectable in the solvent or blend of solvents.

18. (canceled)

19. The method of claim 15, wherein the liquid solvent comprises more than 92 wt % of at least one solvent selected from an ester solvent, a carbonate solvent, a fluoro-ether solvent, a phosphate solvent, a phosphite solvent, a fluoro-ester solvent, an anhydride solvent, an amide solvent, a cyclic-ether solvent, a cyclic-ester solvent, a cyclic-sulfate solvent, a cyclic-carbonate solvent, a nitrile solvent, a cyclic-phosphate solvent, a sulfate solvent, a sulfone solvent, a sultone solvent, dimethyl carbonate, diethyl carbonate, ethyl methyl carbonate, ethylene carbonate, propylene carbonate, diethylene glycol dimethyl ether (diglyme), triethylene glycol dimethyl ether (triglyme), tetraethylene glycol dimethyl ether (tetraglyme), triethyl phosphate, trimethyl phosphate, triethyl phosphite, trimethyl phosphite, fluoroethylene carbonate, ethyl butyrate, gamma-butyrolactone, gamma-valerolactone, triacetin, tetrahydrofuran, 1,3-dioxolane, acetic anhydride, N,N-dimethylformamide, dimethyl maleate, diethyl maleate, diallyl maleate, dimethyl malonate, diethyl malonate, dimethyl oxalate, diethyl oxalate, anisole, ethyl phenyl ether, methoxy perfluorobutane, methoxy perfluoropropane, ethoxy perfluorobutane, ethoxy perfluoropropane, diethyl ether, dipropyl ether, dibutyl ether, ethylene glycol diethyl ether, ethylene glycol dipropyl ether, ethylene glycol dibutyl ether, ethylal, triethyl orthoformate, sulfolane, 3-methyl sulfolane, 1,3-propane sultone, 1,4-butane sultone, 1,3,2-dioxathiolane 2,2-dioxide, 1,3,2-dioxathiane 2,2-dioxide, tetramethylene sulfoxide, 2,2-dimethoxy-propane, butyric anhydride, 1,1,2,2-tetrafluoroethyl-2,2,3,3-tetrafluoropropyl ether, 1,1,2,2-tetrafluoroethyl 2,2,2-trifluoroethyl ether, methyl (2,2,2-trifluoroethyl) carbonate, hexafluoroisopropyl methyl ether, hexafluoroisopropyl ethyl ether, hexafluoroisopropyl propyl ether, hexafluoroisopropyl butyl ether, tris(2,2,2-trifluoroethyl) phosphite, methyl trifluoroacetate, ethyl trifluoroacetate, propyl trifluoroacetate, isopropyl trifluoroacetate, butyl trifluoroacetate, methyl cyanoformate, ethyl cyanoformate, and combinations thereof.

20. The method of claim 15, wherein the acidic precursor has the formula ROH, where R is selected from an alkyl group, a fluoroalkyl group, a cyano-alkyl group, a functionalized alkyl group, a carboxyl group, a fluoro-carboxyl group, a functionalized carboxyl group, a phenyl group, a fluoro-phenyl group, a functionalized phenyl group, a sulfonyl group, a silyl group, and a nitrile group.

21. The method of claim 15, wherein the reaction reaches a conversion of borohydride salt to borate ester salt that is more than 50%.

22. An energy storage device comprising:
at least one negative electrode; and
at least one positive electrode; and
an electrolyte coupling the at least one negative electrode to the at least one positive electrode, wherein the electrolyte comprises:
at least one sodium borate ester salt; and
at least one supplemental salt, or a combination of two or more supplemental salts; and
at least one solvent.

23-30. (canceled)

31. A battery pack comprising the energy storage according to claim 1.

32. An electronic device comprising the battery pack of claim 31.

33. The energy storage device of claim 1, wherein the at least one sodium borate ester salt comprises a fluoro-containing group.

34. The energy storage device of claim 1, wherein the at least one sodium borate ester salt comprises a sodium borate ester salt of formula:
NaB(OR)₄
wherein:
each R is independently selected from fluoroalkyl group, fluoro-carboxyl group, and fluoro-phenyl group.
